(19) United States
(12) Patent Application Publication
(10) Pub. No.: US 2026/0287380 A1
(43) Pub. Date: Sep. 24, 2026

(54) SYSTEM

(71) Applicant: SoftBank Group Corp., Tokyo (JP)

(72) Inventor: Taro HONDA, Tokyo (JP)

(73) Assignee: SoftBank Group Corp., Tokyo (JP)

(21) Appl. No.: 19/550,256

(22) Filed: Feb. 26, 2026

Related U.S. Application Data
(60) Provisional application No. 63/773,610, filed on Mar. 18, 2025.

(51) Int. Cl. G01C 21/36; G01C 21/34; G06N 3/045

(52) U.S. Cl. CPC G01C 21/3629; G01C 21/3484; G01C 21/3492; G06N 3/045

(57) ABSTRACT

A system includes a processor that is configured to receive a voice input from a driver, convert the voice input into text data, analyze the text data to determine an intent of the driver, set a destination based on the determined intent, acquire real-time traffic information, calculate an optimal route to the destination based on the real-time traffic information, and provide voice guidance to the driver along the optimal route.

### CROSS-REFERENCE TO RELATED APPLICATION

This application claims the benefit of U.S. Provisional Application No. 63/773,610, filed on Mar. 18, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In-vehicle navigation systems and driver assistance systems have conventionally operated as separate and functionally limited solutions. Many existing navigation systems merely calculate routes based on static map data or limited traffic information, and do not flexibly interpret a driver's natural language instructions. As a result, a driver is often required to input destinations through cumbersome manual operations or constrained menu selections, which can distract the driver and reduce safety during driving.

Furthermore, conventional vehicle monitoring systems typically provide only basic warning indications, such as simple indicator lights for low fuel or engine malfunction, without integrating such information into route planning or providing context-aware guidance. These systems often fail to provide timely and comprehensible feedback about overall vehicle status in a way that assists the driver in making safe and efficient driving decisions.

In addition, many safe driving support systems do not perform continuous and integrated analysis of a driver's driving pattern using motion sensors such as acceleration sensors and gyroscopes.

Even when such sensors are used, the systems frequently provide generic alerts that are not closely linked to real-time navigation or current driving context, thereby limiting their effectiveness in changing driver behavior.

Moreover, although external traffic information providers can supply real-time information such as congestion, accidents, road construction, and weather conditions, existing systems do not always optimize routing by fully exploiting this information. Drivers may receive delayed or suboptimal route updates, resulting in increased travel time, reduced comfort, and potentially higher risk in hazardous conditions.

Accordingly, there is a need for an integrated in-vehicle system that combines voice recognition, natural language processing, navigation control, vehicle status monitoring, driving behavior analysis, and external traffic information acquisition. Such a system should enable the driver to specify destinations naturally by voice, automatically interpret the driver's intent, calculate optimal routes based on real-time traffic and vehicle status, and provide both navigation guidance and personalized safe driving advice in a coordinated manner, thereby enhancing safety, convenience, and driving comfort.

### SUMMARY

To solve the foregoing problems, the invention provides a system comprising a processor configured to integrate voice-based interaction, navigation control, vehicle condition monitoring, safe driving support, and external traffic information utilization.

According to one aspect of the invention, the system comprises a processor configured to receive a voice input from a driver, convert the voice input into text data, analyze the text data to determine an intent of the driver, set a destination based on the determined intent, acquire real-time traffic information, calculate an optimal route to the destination based on the real-time traffic information, and provide voice guidance to the driver along the optimal route. By enabling direct voice input and intent analysis, the system allows the driver to specify destinations and navigation commands in natural language, thereby reducing manual operations and supporting safer driving.

According to another aspect of the invention, the system comprises the same processor further configured to acquire vehicle data including at least a remaining fuel amount, tire air pressure, and engine status from sensors mounted on a vehicle, analyze the vehicle data to report a state of the vehicle to the driver, monitor a driving pattern of the driver by using at least an acceleration sensor and a gyroscope, detect dangerous driving behaviors including at least sudden braking and sudden acceleration based on the driving pattern, and provide safe driving advice to the driver by voice based on the detected dangerous driving behaviors. By continuously monitoring both vehicle conditions and driver behavior, the system can generate timely alerts and personalized advice that improve safety and help prevent accidents or vehicle damage.

According to a further aspect of the invention, the system comprises the processor further configured to access, via the Internet, a database of an external traffic information provider, acquire the real-time traffic information including at least congestion, accidents, road construction, and weather information from the database, evaluate a plurality of route options based on the acquired real-time traffic information, select the optimal route from among the plurality of route options, and guide the driver along the selected optimal route. By dynamically evaluating route options in view of real-time traffic conditions, the system can reduce travel time, avoid hazardous areas, and provide a more comfortable and efficient driving experience.

Through the combination of these functions by a single integrated processor, the system according to the invention enables natural voice-based destination input, context-aware navigation guidance, comprehensive vehicle status reporting, and personalized safe driving assistance, all coordinated with real-time external traffic information, thereby effectively solving the above-mentioned problems.

The term “system” refers to an integrated arrangement of hardware and software components that collectively perform voice processing, navigation control, vehicle monitoring, safe driving assistance, and communication functions as recited in the claims.

The term “processor” refers to one or more hardware processing units, such as a CPU, GPU, ASIC, FPGA, or a combination thereof, configured to execute instructions to perform the functions described in the claims, including voice recognition, natural language analysis, route calculation, vehicle data analysis, and communication control.

The term “voice input” refers to an audio signal representing spoken words or utterances provided by the driver and captured by one or more microphones.

The term “driver” refers to a human operator who controls the vehicle and interacts with the system, for example by providing voice inputs and receiving guidance or advice.

The term “text data” refers to a digital representation of linguistic content expressed as characters, words, or phrases, obtained by converting voice input into a textual format suitable for analysis.

The term “intent” refers to a semantic meaning or purpose underlying the driver's voice input, such as a request to navigate to a destination, modify a route, or obtain information, as determined by analysis of the text data.

The term “destination” refers to a geographic location, such as a specific address, point of interest, facility, or region, to which the driver intends to travel and for which the system calculates a route.

The term “real-time traffic information” refers to traffic-related data that is updated at short intervals and reflects current or near-current conditions on roads, including at least congestion, accidents, road construction, and weather information.

The term “optimal route” refers to a route selected by the processor from among multiple candidate routes based on one or more evaluation criteria, such as estimated travel time, distance, safety, or driver preferences, using the real-time traffic information.

The term “voice guidance” refers to audible instructions generated by the system, typically through text-to-speech processing or pre-recorded messages, that inform the driver about navigation maneuvers, route status, or safety advice.

The term “vehicle data” refers to information acquired from one or more sensors mounted on the vehicle, including at least remaining fuel amount, tire air pressure, engine status, and optionally other parameters such as brake pad condition or oil level.

The term “remaining fuel amount” refers to a quantitative indication of fuel available in the vehicle, such as a level, volume, or percentage of tank capacity, as detected by a fuel sensor.

The term “tire air pressure” refers to the pressure of air within each tire of the vehicle, as measured by one or more tire pressure sensors.

The term “engine status” refers to operational information of the vehicle's engine, including at least error codes, temperature, or performance indicators, as detected by engine-related sensors or an onboard diagnostic system.

The term “state of the vehicle” refers to an overall condition of the vehicle derived from vehicle data, including fuel level, tire pressure, engine condition, and optionally other parameters relevant to safety and operability.

The term “driving pattern” refers to characteristics of the driver's operation of the vehicle over time, including acceleration, braking, steering, and speed changes, as derived from sensor measurements.

The term “acceleration sensor” refers to a sensor configured to measure linear acceleration of the vehicle along one or more axes.

The term “gyroscope” refers to a sensor configured to measure angular velocity or rotational movement of the vehicle about one or more axes.

The term “dangerous driving behaviors” refers to driving actions that may increase risk of accidents or reduce safety, including at least sudden braking and sudden acceleration, and optionally other behaviors such as abrupt steering or excessive cornering speed.

The term “sudden braking” refers to a rapid reduction in vehicle speed over a short time interval that exceeds a predetermined deceleration threshold.

The term “sudden acceleration” refers to a rapid increase in vehicle speed over a short time interval that exceeds a predetermined acceleration threshold.

The term “safe driving advice” refers to information, instructions, or recommendations provided to the driver, typically by voice, to encourage safer driving practices based on detected dangerous driving behaviors or driving patterns.

The term “Internet” refers to a global system of interconnected computer networks that use standardized communication protocols to transmit data between the system and external servers or services.

The term “database of an external traffic information provider” refers to a remotely located data storage system operated by an entity other than the vehicle or the system, which stores and supplies traffic-related information accessible via the Internet.

The term “congestion” refers to a traffic condition in which the density of vehicles on a road segment is high, resulting in reduced speeds and increased travel times compared to normal flow.

The term “accidents” refers to traffic incidents, collisions, or crashes involving one or more vehicles or other road users, as reported or detected by the external traffic information provider.

The term “road construction” refers to temporary or ongoing works on or along a road, including lane closures, detours, or maintenance operations, that may affect traffic flow.

The term “weather information” refers to data regarding environmental conditions affecting roads, such as rain, snow, fog, ice, wind, or visibility, as provided by the external traffic information provider.

The term “route options” refers to a plurality of candidate paths between a start location and a destination, each defined on a road network and differing in at least one segment or condition.

The term “selected optimal route” refers to the specific one of the route options that is chosen by the processor as the optimal route according to the evaluation criteria and real-time traffic information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

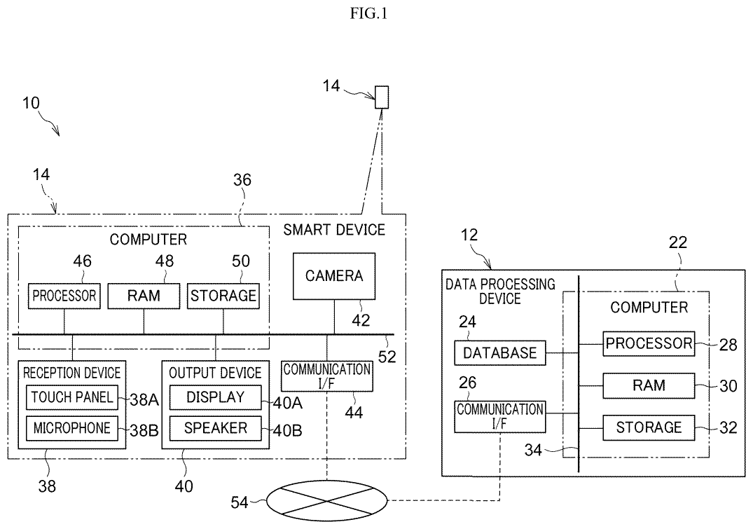

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

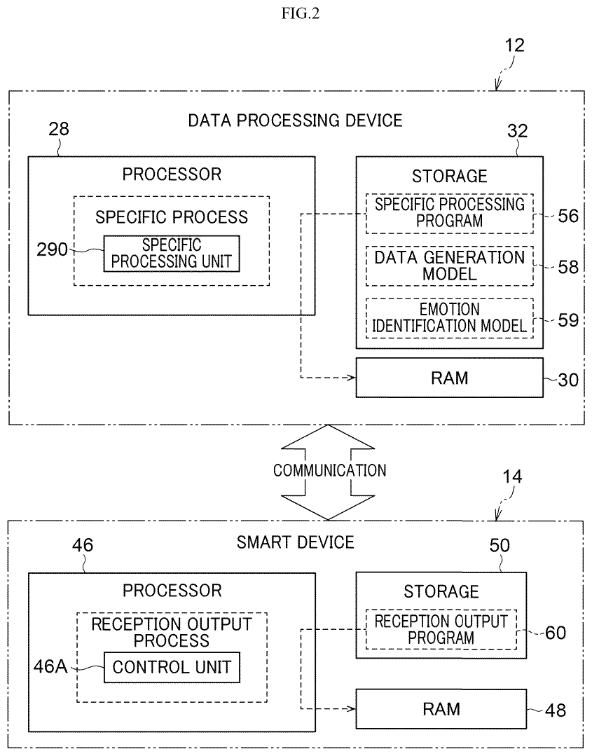

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional in-vehicle navigation and driver-assistance systems rely on fixed, rule-based software pipelines for speech interpretation, route calculation, and feedback generation. In such systems, an intent classification model and a limited set of predefined templates are typically used to map driver utterances to commands. This architecture suffers from several technical problems. First, it is difficult to robustly handle diverse natural-language inputs, ambiguous expressions, or evolving user preferences without frequent manual updates to grammars and rule sets, which leads to brittle behavior and increased maintenance overhead. Second, the integration of heterogeneous data streams, such as real-time traffic data, weather data, detailed vehicle state data, and motion sensor data, is often performed in isolated modules with rigid interfaces, which restricts the ability of the system to compute globally optimized routes and holistic advice in real time. Third, existing systems usually provide generic, non-adaptive guidance that is not tailored to the specific driving style or current vehicle condition, thereby under-utilizing available sensor information and limiting the effectiveness of safety interventions.

From a computer technology perspective, these limitations manifest as inefficiencies and rigidity in the underlying information-processing pipeline. The system must maintain separate, specialized components for intent recognition, route planning, vehicle diagnostics, and safety advice, each with its own handcrafted logic, resulting in duplicated data transformations and increased latency due to repeated parsing and formatting steps. Moreover, the system lacks a unified abstraction to express complex queries over multimodal context (speech, location, vehicle state, and driving metrics), which prevents flexible computation of context-aware outputs. As a result, the utilization of processing resources and communication bandwidth between the vehicle and remote servers is sub-optimal, and the scalability of the software architecture is constrained when new functionalities or data sources are added.

Accordingly, there is a need for a computer-implemented technique that improves the way an in-vehicle system processes, combines, and interprets natural-language input, sensor data, and external information sources. In particular, there is a need for an architecture in which a processor can dynamically construct and use machine-interpretable prompt sentences to a generative AI model, obtain structured information and adaptive guidance in response, and efficiently integrate these outputs with navigation and safety logic. By restructuring the processing pipeline in this manner, the system can achieve more accurate intent understanding, more efficient route computation under complex constraints, and more effective, personalized feedback generation, thereby improving the operation of the computer system itself in terms of flexibility, maintainability, and real-time performance.

The specific processing by the specific processing unit 290 of the data processing device 12 in Example 1 is realized by the following means.

The present invention provides a server comprising a processor configured to acquire audio input from a vehicle occupant and convert the audio input into text data, generate prompt sentences for a generative AI model based on the text data and context information including at least vehicle position information, input the prompt sentences into the generative AI model, obtain structured information including driver intent, constraint conditions relating to candidate destinations, and advice content from the generative AI model, set destinations and calculate travel routes based on the structured information and road network information while taking into account traffic information and weather information acquired from external information sources, collect and aggregate vehicle state data and driving-pattern data obtained from sensors mounted on the vehicle, generate additional prompt sentences including summary information or statistical information derived from the vehicle state data and driving-pattern data, input the additional prompt sentences into the generative AI model to obtain maintenance explanation information and personalized safe-driving guidance, and present at least one of route guidance information, maintenance explanation information, and safe-driving guidance to the vehicle occupant and dynamically update at least one of the destinations, the travel routes, and the guidance based on voice instructions or operation inputs from the vehicle occupant. This enables a unified, prompt-driven processing architecture in which the server can flexibly orchestrate natural-language understanding, multimodal context fusion, route computation, and adaptive feedback generation using the generative AI model as a general-purpose reasoning and content-generation component, thereby reducing the need for rigid rule-based modules, improving computational efficiency and scalability of the navigation and assistance software stack, and enhancing real-time responsiveness and personalization of in-vehicle guidance.

The term “audio input” refers to an analog or digital signal representing spoken utterances of a vehicle occupant, captured by a sound-capturing device and supplied to a processing component for conversion into text data.

The term “text data” refers to digital character data obtained by converting audio input into a sequence of symbols representing words or other linguistic units, which is suitable for processing by a natural-language understanding component.

The term “context information” refers to auxiliary data associated with a driver request, including at least vehicle position information and optionally time, vehicle state, route status, and historical interaction data, which is used to interpret the driver's intent.

The term “vehicle position information” refers to location data indicating a current or recent geographic position of a vehicle, expressed, for example, as coordinates, map-matched positions, or similar location descriptors.

The term “prompt sentence” refers to a machine-interpretable instruction, represented as text data, that includes at least part of the text data and context information and is formatted for input to a generative AI model to cause the model to produce a specific type of output.

The term “generative AI model” refers to a machine-learned computational model, such as a large language model, configured to generate text or other content in response to input data including prompt sentences.

The term “structured information” refers to data produced by the generative AI model in a predefined, machine-readable format, such as a key-value structure, that encodes at least driver intent, constraint conditions, and optionally other parameters relevant to navigation or guidance.

The term “driver intent” refers to information indicating a desired action or goal of a vehicle occupant, such as navigating to a destination, modifying a route, requesting status information, or obtaining advice.

The term “constraint conditions” refers to parameters that restrict or qualify a requested action or destination, including, for example, distance limits, route preferences, time constraints, or facility requirements.

The term “candidate destination” refers to a location that is a possible target for navigation, identified based on at least the driver intent, constraint conditions, and context information.

The term “road network information” refers to data describing a set of road segments, intersections, and related attributes, which are used by a routing algorithm to compute travel routes.

The term “traffic information” refers to data regarding conditions on roads, including at least congestion, incidents, closures, and other dynamic factors that affect travel time or safety.

The term “weather information” refers to data indicating environmental conditions relevant to driving, such as precipitation, temperature, visibility, and hazards caused by weather.

The term “travel route” refers to a sequence of road segments or waypoints computed between an origin and a destination, optionally including intermediate stopping points, and used as a basis for route guidance.

The term “route guidance information” refers to data and content derived from a travel route, including maneuver instructions, distances, and estimated arrival times, which are presented to a vehicle occupant by audio and/or visual output.

The term “vehicle state data” refers to data obtained from sensors or control units of a vehicle, including at least fuel level, tire pressure, engine condition, and similar operational parameters.

The term “detector” refers to any sensor device or sensing subsystem mounted on a vehicle that is configured to measure a physical quantity or operational status and provide corresponding digital data.

The term “route change request” refers to data generated based on vehicle state data or other conditions, indicating that an existing travel route should be modified, for example, to include a recommended stopping location or to avoid a risk.

The term “recommended stopping location” refers to a destination or intermediate point, such as a refueling point or rest area, selected based on vehicle state data or driver condition to address a detected need.

The term “driving pattern” refers to a set of characteristics describing how a vehicle occupant operates a vehicle over time, derived at least from acceleration information, angular velocity information, and optionally speed and timing data.

The term “acceleration information” refers to data representing linear acceleration of a vehicle along one or more axes, obtained from at least one motion sensor.

The term “angular velocity information” refers to data representing rotational motion of a vehicle, such as yaw, pitch, or roll rate, obtained from at least one motion sensor.

The term “advice content” refers to information generated by the generative AI model that provides guidance or recommendations relating to driving behavior, vehicle operation, or route selection.

The term “safe-driving advice” refers to advice content that instructs or encourages a vehicle occupant to adopt safer driving behavior, such as increasing following distance, reducing abrupt maneuvers, or taking breaks.

The term “voice instruction” refers to a command or request given by a vehicle occupant in spoken form, captured as audio input and interpreted by the system.

The term “operation input” refers to a command or request given by a vehicle occupant through a non-verbal interface, such as a touch panel, physical switch, or other input device.

The term “summary information” refers to compact, aggregated data derived from vehicle state data or diagnostic information, suitable for inclusion in a prompt sentence to the generative AI model.

The term “diagnostic information” refers to data indicating detected faults, error codes, or abnormal conditions in a vehicle, obtained from on-board diagnostic subsystems or similar components.

The term “maintenance explanation information” refers to content generated by the generative AI model that explains, in human-understandable terms, a vehicle condition, a diagnostic result, or a maintenance requirement.

The term “personalized safe-driving guidance” refers to safe-driving advice that is tailored to an individual vehicle occupant, generated based on statistical information relating to the driving pattern of that occupant.

The term “statistical information” refers to numerical or categorical data summarizing one or more aspects of the driving pattern, such as frequencies or rates of specific events, averages, or distributions.

The term “audio output” refers to sound presented to a vehicle occupant by a sound-producing device, such as a loudspeaker, including synthesized speech conveying guidance or advice.

The term “visual display” refers to an output device configured to present information in visual form, such as text, graphics, or icons, to a vehicle occupant.

In one embodiment, the system includes a server, a terminal, and a plurality of sensors mounted on a vehicle. The terminal is mounted in the vehicle and includes at least one microphone, at least one loudspeaker, a display device such as a touch-sensitive display, a positioning unit such as a satellite-based positioning receiver, and an in-vehicle network interface such as a controller area network interface. The server is implemented on one or more computing devices including at least one processor, a volatile storage device, and a non-volatile storage device, and executes software modules providing a speech processing function, a navigation control function, a vehicle-state analysis function, a driving-pattern analysis function, and a generative AI interaction function.

The terminal acquires audio input from the user via the microphone. The terminal executes a signal-processing module on a processor such as an embedded central processing unit or digital signal processor, and samples the analog audio signal via an audio codec at a predetermined sampling frequency, for example 16 kHz, and a predetermined bit depth, for example 16 bits per sample. The terminal applies a noise-reduction algorithm, such as a spectral subtraction algorithm or a recurrent neural-network-based denoising algorithm comparable to RNNoise, to the sampled frames. The noise-reduction algorithm computes a time-frequency representation such as a short-time Fourier transform, estimates a noise spectrum from non-speech segments, and attenuates the estimated noise components to improve the signal-to-noise ratio of the speech signal in the cabin environment.

The terminal converts the denoised speech signal into text data by executing an automatic speech recognition engine. The terminal may employ a model comparable to a hybrid hidden Markov model and deep neural network system, or an end-to-end model such as a connectionist temporal classification network or attention-based encoder-decoder network. The terminal computes acoustic features including, for example, Mel-frequency cepstral coefficients and their temporal derivatives over sliding windows, and normalizes the features by mean and variance. The terminal feeds the features to the acoustic network, which may be formed as a stack of convolutional layers and recurrent layers such as long short-term memory layers, and obtains a sequence of state likelihoods or sub-word distributions. The terminal then applies a decoding algorithm such as a beam-search-based Viterbi decoder using a statistical language model or a neural language model to determine the most likely sequence of tokens representing the user's utterance. In this way, the speech-recognition process is technically improved by combining cabin-specific denoising and context-aware decoding, yielding higher recognition accuracy and reduced latency compared with a generic, server-side recognition scheme.

The terminal obtains context information including at least vehicle position information from the positioning unit. The positioning unit determines the vehicle position based on signals from a global navigation satellite system and optionally assisted positioning signals, and outputs position coordinates and estimated accuracy. The terminal also obtains additional context information, such as current time, fuel level obtained via the in-vehicle network interface from a vehicle control device, and current travel route status. The terminal bundles the text data and the context information into a structured message and transmits the message to the server via a communication interface such as a mobile-communication module using a secure transport protocol such as a transport layer security-based protocol. By aggregating context at the terminal and sending a compact representation to the server, the system reduces uplink bandwidth and server-side parsing overhead.

The server receives the message and stores the text data and context information in a data structure such as a record in a relational data store or a document in a key-value store. The server executes a natural-language preprocessing module that tokenizes the text data, performs part-of-speech tagging, and computes syntactic dependencies using a parsing algorithm such as a transition-based parser. The server identifies candidate intents and entities using a classifier, which may be a neural classifier or a gradient-boosted decision-tree model trained on labeled navigation utterances. These preprocessing operations transform the raw text into an intermediate representation that is more suitable for subsequent generative processing.

The server constructs a prompt sentence for a generative AI model based on the text data, the context information, and the intermediate representation from the natural-language preprocessing module. The server concatenates the fields into a single text string according to an instruction template. For example, the server may generate a prompt sentence such as:
“The user utterance is: ‘I want to go to the nearest cafe.’
The current GPS location is: latitude 35.6812, longitude 139.7671.
The task: Analyze the utterance and the location, infer the user's navigation intent, and output the intent, the type of place, and relevant constraints such as distance and whether the place should be currently open.”

The server inputs the prompt sentence to the generative AI model. In one embodiment, the server implements the generative AI model as a transformer-based neural network deployed on one or more general-purpose processors with a vector-processing extension and one or more graphics-processing units. The generative AI model includes an embedding layer for converting input tokens into dense vectors, a plurality of self-attention layers that compute attention scores between all pairs of token positions using a scaled dot-product mechanism, and feed-forward layers that transform intermediate representations using non-linear activation functions. The generative AI model is trained on a mixture of general-language corpora and domain-specific corpora including navigation requests and vehicle-related dialogs.

The server trains the generative AI model by minimizing a loss function such as a cross-entropy loss between predicted output tokens and reference tokens over large training sequences. The server updates model parameters using an optimization algorithm such as stochastic gradient descent with adaptive moment estimation. The server may perform fine-tuning on a smaller set of labeled prompt-response pairs that encode structured outputs for navigation tasks, such as mapping utterances to intent labels and constraints. During training, the server may apply data-augmentation techniques such as paraphrasing utterances, randomly masking terms, or perturbing numeric values, to improve the robustness of the model to the variability of user expressions.

The server constrains the output of the generative AI model by including in the prompt sentence explicit instructions about the desired output structure, thereby obtaining structured information that can be parsed deterministically. For example, the prompt sentence may specify:
“The task: From the user utterance and context, identify the navigation intent, the destination type, and any constraints such as distance or whether the destination should be currently open. Answer using short phrases separated by semicolons in the order: intent; destination type; constraints.”

By using such non-conventional, prompt-driven structuring rules, the server avoids reliance on rigid, hand-crafted rule sets and instead leverages the generative AI model to map heterogeneous user inputs and context into a normalized decision space. This reduction of mapping complexity improves computation efficiency because the navigation control module can operate directly on a compact set of normalized fields rather than performing repeated parsing and re-classification.

The server receives the output of the generative AI model, splits the output according to the specified separators, and maps the textual fields to predefined values in an internal schema. The server thereby obtains structured information that includes at least a driver intent, one or more constraint conditions, and parameters describing candidate destinations, such as a place category and optional distance or time limits. The server validates the fields against a schema table and stores the structured information in memory for use by other modules.

The server determines one or more candidate destinations based on the structured information and road-network-related data. The server queries a spatial data store containing road network information and points-of-interest data. The server may employ spatial indexing structures such as R-trees or kd-trees to efficiently retrieve locations of a specified category within a specified radius from the current vehicle position. The server computes the distance and estimated travel time between the current position and each candidate destination using cost functions that incorporate base segment travel times, speed limits, and current traffic conditions. The server filters out candidates that violate constraint conditions, such as being beyond a maximum distance or not satisfying an “open” condition, and selects a destination that optimizes a cost function combining distance, estimated travel time, and user preferences.

The server performs route computation by executing a routing algorithm on a graph representation of the road network. The server represents the road network as a directed graph whose nodes correspond to intersections and whose edges correspond to road segments with attributes such as length, expected travel time, lane count, and restrictions. The server updates edge weights dynamically using traffic information and weather information received from external information sources via a network interface. For example, the server increases the weight of edges associated with congested segments or adverse weather conditions. The server then executes an algorithm such as a heuristic-based shortest-path algorithm or a contraction-hierarchy-based algorithm to obtain an optimal or near-optimal travel route from the vehicle position to the selected destination. By combining dynamically adjusted weights with efficient graph algorithms executed on a multi-core server, the system reduces computation time for route updates while maintaining accuracy under changing conditions.

The server converts the travel route into route guidance information including maneuver instructions, distances, and estimated arrival times. The server formats this information into a message that the terminal can interpret and send to a text-to-speech engine and map-rendering engine. The server transmits the message to the terminal via the communication interface. The server may compress the geometric path using polyline encoding or similar techniques to reduce data size, thereby reducing communication load and improving responsiveness.

The terminal receives the route guidance information and updates the display device to render a map and the travel route. The terminal may use a map-rendering engine that runs on a graphics processor in the terminal to draw the current vehicle position and a highlighted path. The terminal synthesizes navigation instructions by passing maneuver texts to a text-to-speech engine implemented in software on the terminal or accessed via the server. The terminal outputs the synthesized audio through the loudspeaker. Because the route guidance information has already been normalized and structured by the server, the terminal can perform rendering with minimal additional computation, which reduces processor load and power consumption in the vehicle.

The terminal acquires vehicle state data via the in-vehicle network interface from one or more vehicle control devices. The vehicle state data includes, for example, fuel level, coolant temperature, brake pad wear estimates, and tire pressure values. The terminal executes a threshold-based detection module that compares incoming values against predetermined thresholds. When the terminal detects a condition such as fuel level below a specified threshold, the terminal constructs a state summary record and transmits it to the server. The terminal may also output a preliminary local warning to the user.

The server receives the state summary record and aggregates it with historical state data stored in a persistent store. The server constructs a prompt sentence for the generative AI model that includes textual descriptions of diagnostic codes and trends, as well as a task specification. For example, the server may generate a prompt sentence such as:
“Vehicle data: Diagnostic code P0420 is present, average engine temperature has been slightly above normal during the last 200 kilometres, and the mileage since the last service is 18,000 kilometres.
The task: Explain to a normal driver what this situation probably means, how urgent it is, and what actions should be taken. Use simple language and limit the explanation to three short paragraphs.”

The server inputs the prompt sentence to the generative AI model, which produces maintenance explanation information in natural language. The server may apply a post-processing filter to enforce length constraints and remove irrelevant content. The server then transmits the explanation text to the terminal. The terminal converts the explanation text to audio and optionally displays the text on the display device. In this manner, the vehicle occupant can receive an easily understandable explanation of a complex diagnostic situation, and the computational complexity of mapping raw diagnostic codes to human-readable advice is offloaded to a generative model that has been trained on diverse textual data.

The terminal acquires acceleration information and angular-velocity information from inertial sensors mounted in the vehicle or integrated into the terminal. The terminal samples the sensor outputs at a relatively high frequency and computes derived features such as jerk, lateral acceleration peaks, and yaw-rate changes. The terminal detects events such as harsh braking or rapid lane changes based on thresholds on these features. The terminal maintains statistical information summarizing the driving pattern, such as counts of specific events per unit distance and distributions of speeds relative to posted limits.

The server receives the statistical information at intervals and stores these data in a user-specific profile. The server then constructs a prompt sentence for the generative AI model that expresses the statistical information in natural language and defines a task to generate personalized safe-driving guidance. For example, the server may use a prompt sentence such as:
“Driving metrics for the last 120 minutes: There were 15 instances of strong braking, most of them at speeds above 50 kilometres per hour, the estimated following distance has been approximately one second, and the driving time without a break has been 120 minutes.
The task: Produce three short, concrete safety tips addressed directly to the driver using ‘you’ and avoiding technical terms, focusing on practical suggestions for safer driving.”

The server provides this prompt sentence to the generative AI model and receives as output several short advice sentences. The server returns these sentences to the terminal, which presents them by audio output or visual display. Because the advice is generated based on statistics that are computed automatically and are not easily perceptible to the driver, the system provides new insights that are not attainable by simple human observation.

From a computer-technology viewpoint, the system improves the operation of the computing environment by using prompt-driven interaction with a generative AI model as a unifying abstraction for multiple heterogeneous tasks, including intent extraction, constraint resolution, maintenance explanation, and driving-pattern analysis. The server reduces the number of separate domain-specific rule engines, which simplifies the software architecture and decreases the amount of redundant parsing and formatting. The server uses structured prompt templates and constrained output formats to ensure that the generative model's outputs can be parsed with low computational overhead and low error rate, thereby improving data-management efficiency. The use of spatial indexing structures, dynamic edge-weight adjustment, and efficient shortest-path algorithms in the navigation control further reduces route-calculation latency.

The generative AI model is trained and employed in a way that differs from mere human-task automation. The model is not simply emulating human decision-making, but is instead integrated into a non-conventional computational pipeline where specific prompt structures and output constraints are designed to optimize the interface between free-form natural language and fixed-schema data used by the navigation and safety modules. The combination of context-rich prompts and schema-constrained outputs allows the system to process a wider range of user inputs with fewer deterministic rules, thereby reducing the amount of hand-engineered code and enabling faster adaptation to new scenarios. As a result, the system improves overall computation speed and robustness in handling noisy, ambiguous inputs while maintaining a compact and manageable data flow.

In alternative embodiments, the generative AI model may execute entirely on the server, on an edge-computing device proximate to the vehicle, or on the terminal itself if the terminal includes sufficient processing resources. The terminal may offload only part of the processing, for example using an on-device model for simple intent classification and a server-side generative AI model for complex explanations and multi-constraint routing. The server may also adjust the complexity of the generative AI model, such as the number of transformer layers or attention heads, according to available computation resources and latency requirements. The system may employ different types of in-vehicle network interfaces, different kinds of inertial sensors, or different speech-recognition architectures while preserving the overall prompt-driven integration pattern.

In another embodiment, the server may generate different prompt sentences for different tasks within a single session, such as a first prompt sentence to extract intent and constraints, a second prompt sentence to clarify ambiguous user instructions, and a third prompt sentence to generate post-trip feedback. The server may also cache prompt-response pairs and use them to fine-tune the generative AI model incrementally, thereby improving the quality of generated content over time while monitoring for bias and errors. These variations provide additional flexibility while maintaining the core technical improvement of unifying multimodal context processing and adaptive guidance generation through controlled interactions with a generative AI model.

Through these configurations, the server, the terminal, and the sensors cooperate to implement the claimed system, and the system achieves technical effects including improved accuracy and robustness of speech-based navigation, reduced processing latency for route calculation and guidance updates, improved data-management efficiency through structured interaction with a generative AI model, and enhanced safety and maintenance support through adaptive, context-aware advice that is tightly coupled with vehicle-state monitoring and driving-pattern analysis.

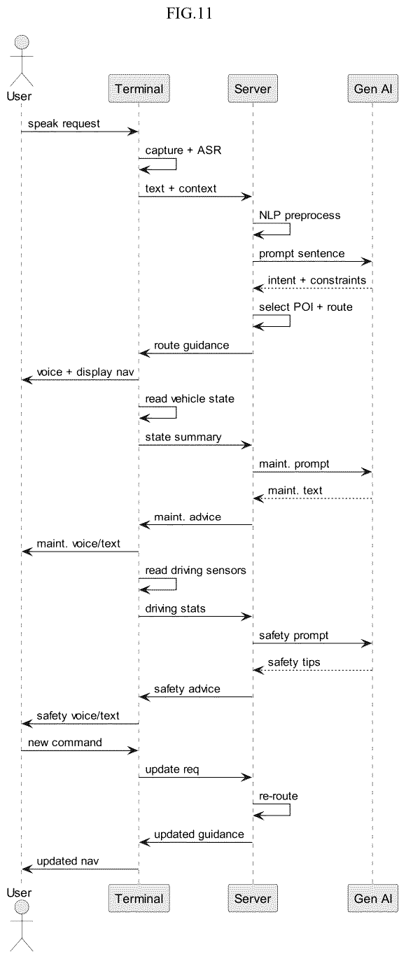

The following describes the processing flow using FIG. 11.

### Step 1:

The user speaks a request such as “I want to go to the nearest cafe” inside the vehicle.
Input: Human speech (analog sound waves).
Output: Acoustic pressure variations in the cabin air.
The user generates the audio signal that will be captured and processed by the terminal.

### Step 2:

The terminal captures the user's speech via a microphone and digitizes the audio.
Input: Acoustic pressure variations.
Output: A stream of digital audio samples (for example, 16-kHz, 16-bit PCM frames).
The terminal uses an audio codec to sample the analog signal at a fixed sampling rate and bit depth, buffers consecutive frames into memory, and timestamps each buffer for later alignment with other sensor data.

### Step 3:

The terminal performs front-end signal processing and noise reduction on the audio.
Input: Buffered raw PCM frames.
Output: Denoised PCM frames with reduced background noise.
The terminal computes short-time Fourier transforms for each frame, estimates a noise spectrum from non-speech intervals, and subtracts or attenuates the estimated noise components, thereby increasing the signal-to-noise ratio and improving downstream recognition accuracy.

### Step 4:

The terminal converts the denoised audio into text using an automatic speech recognition engine.
Input: Denoised PCM frames.
Output: Text data representing the user utterance (for example, “I want to go to the nearest cafe”).
The terminal extracts acoustic features such as Mel-frequency cepstral coefficients and their derivatives, normalizes feature vectors, feeds them into a neural acoustic model (for example, an encoder network with convolutional and recurrent layers), and runs a decoding algorithm such as beam search with a language model to obtain the most probable token sequence.

### Step 5:

The terminal acquires context information related to the utterance.
Input: Signals from a positioning unit, vehicle control units, and an internal clock.
Output: Context information including at least current GPS coordinates, time, and selected vehicle-state indicators.
The terminal reads the latest latitude and longitude from the positioning unit, reads fuel level and other key parameters from the vehicle network, and packages these values with a timestamp into a context record.

### Step 6:

The terminal constructs a request message and transmits it to the server.
Input: Text data of the utterance and the context record.
Output: A structured request message sent over a secure network channel.
The terminal embeds the text and context into a structured object, opens or reuses a secure connection using a transport protocol with encryption, and sends the object to a designated endpoint on the server.

### Step 7:

The server receives the request and performs initial parsing and logging.
Input: The structured request message from the terminal.
Output: Parsed text and context objects stored in memory, and a log entry in persistent storage.
The server validates the message format, extracts fields such as utterance text, coordinates, and fuel level, stores them in internal data structures, and writes an entry to a log or database for traceability and potential model retraining.

### Step 8:

The server performs classical natural-language preprocessing on the utterance.
Input: Utterance text data.
Output: An intermediate linguistic representation including tokens, part-of-speech tags, and dependency relations.
The server tokenizes the text into words or sub-words, assigns part-of-speech tags using a trained tagger, computes dependency parses to identify syntactic heads and modifiers, and identifies candidate entities and intents using a classifier, forming an enriched representation of the utterance.

### Step 9:

The server generates a prompt sentence for the generative AI model based on the utterance and context.
Input: Utterance text, context information, and the intermediate linguistic representation.
Output: A prompt sentence encoded as a text string.
The server fills an instruction template with the utterance, current location, and any pre-detected entities, and adds explicit instructions about required outputs. The server may, for example, generate a prompt sentence such as:
“The user utterance is: ‘I want to go to the nearest cafe.’
The current GPS location is: latitude 35.6812, longitude 139.7671.
The task: Analyze the utterance and the location, infer the user's navigation intent, and output the intent, the type of place, and relevant constraints such as distance and whether the place should be currently open.”

### Step 10:

The server inputs the prompt sentence into the generative AI model and obtains structured information.
Input: Prompt sentence.
Output: Structured information containing at least driver intent, destination type, and constraint conditions.
The server tokenizes the prompt sentence, feeds token embeddings into a transformer-based neural network, executes multiple self-attention and feed-forward layers to compute contextual representations, and decodes output tokens according to trained parameters. The server constrains the decoding by using instructions in the prompt (for example, specifying output fields and separators), and then parses the output into structured fields such as “navigate_to_place”, “cafe”, and “nearest, open now”.

### Step 11:

The server resolves one or more candidate destinations using map and point-of-interest data.
Input: Structured information (intent, destination type, constraints) and current position.
Output: One or more candidate destination records with coordinates and attributes.
The server queries a spatial database or external map service for points of the specified type within a search radius around the current position, filters candidates based on constraints such as “open now” or distance limits, and ranks them according to a cost function that may combine distance, travel time, and preferences.

### Step 12:

The server computes an optimal travel route to a selected destination.
Input: Selected destination, current position, and dynamic road-network data.
Output: A travel route represented as a sequence of road segments and maneuvers with associated times and distances.
The server loads a road-network graph, updates edge weights using real-time traffic information and weather information, and executes a shortest-path algorithm such as A* or contraction hierarchies to find a path that minimizes travel time or a combined cost. The server then segments the path into maneuver steps and computes estimated times of arrival.

### Step 13:

The server generates route guidance information for the terminal.
Input: The computed travel route and destination metadata.
Output: Route guidance information including maneuver descriptions, distances, ETAs, and encoded geometry.
The server formats each maneuver into a text instruction, encodes the path using a compact polyline or similar scheme, and bundles all guidance elements into a response object optimized for quick decoding and rendering on the terminal.

### Step 14:

The server sends the route guidance information to the terminal.
Input: Route guidance information.
Output: A guidance response transmitted via a secure network channel to the terminal.
The server serializes the response, transmits it over the established connection, and may include additional flags indicating special conditions such as recommended intermediate stops or hazardous segments.

### Step 15:

The terminal receives the route guidance information and updates the navigation display.
Input: Guidance response from the server.
Output: Updated internal route representation and a rendered navigation view on the display.
The terminal decodes the polyline geometry, stores the maneuver list and ETAs, and calls a map-rendering module to draw the route on a 2D or 3D map. The terminal updates the display in real time as new GPS positions are received, moving the vehicle icon along the route.

### Step 16:

The terminal generates and outputs voice guidance based on the route.
Input: Maneuver texts and distance information.
Output: Synthesized speech played through the loudspeaker.
The terminal determines appropriate timing for announcements based on current speed and distance to the next maneuver, sends the selected text to a text-to-speech engine, receives an audio buffer containing synthesized speech, and plays the buffer via the audio subsystem to inform the user of upcoming actions.

### Step 17:

The terminal acquires vehicle state data from the in-vehicle network.
Input: Signals from vehicle control units (for example, fuel level, tire pressure, engine temperature).
Output: A vehicle-state record with normalized parameter values.
The terminal requests or listens for standard diagnostic and status messages, converts raw sensor values to engineering units using calibration data, and aggregates them into a record suitable for analysis and potential transmission to the server.

### Step 18:

The terminal detects abnormal vehicle conditions and generates a state summary.
Input: Vehicle-state record.
Output: A state summary including any detected warnings (for example, “fuel low”) and supporting data.
The terminal compares each parameter to threshold values or allowed ranges, flags any out-of-range parameter, and compiles a summary message that includes the type of issue, current values, and context such as remaining estimated range.

### Step 19:

The server receives and analyzes the state summary for maintenance and routing decisions.
Input: State summary from the terminal.
Output: A decision to request a maintenance explanation and/or a route change.
The server inspects flags in the summary, checks historical records for similar patterns, and determines whether to initiate a maintenance-explanation workflow, suggest an intermediate stop, or both, based on configurable rules and safety policies.

### Step 20:

The server constructs a maintenance-related prompt sentence and sends it to the generative AI model.
Input: Diagnostic information, historical state data, and policy context.
Output: A maintenance-explanation prompt sentence.
The server converts diagnostic codes and trends into plain text, combines them with an explicit instruction, and forms a prompt sentence such as:
“Vehicle data: Diagnostic code P0420 is present, the average engine temperature has been slightly above normal during the last 200 kilometres, and the mileage since the last service is 18,000 kilometres.
The task: Explain to a normal driver what this situation probably means, how urgent it is, and what actions should be taken. Use simple language and limit the explanation to three short paragraphs.”

### Step 21:

The server obtains maintenance explanation information from the generative AI model and returns it to the terminal.
Input: Maintenance-explanation prompt sentence.
Output: Maintenance explanation text suitable for the user.
The server tokenizes the prompt, executes the generative AI model to generate an explanation, optionally truncates or filters the text to enforce length and relevance constraints, and then sends the final explanation text back to the terminal in a response message.

### Step 22:

The terminal presents the maintenance explanation to the user.
Input: Maintenance explanation text from the server.
Output: Audio and/or visual presentation of the explanation.
The terminal displays the text on the screen, converts the text to speech via a text-to-speech engine, and plays the audio through the loudspeaker, thereby informing the user about the condition and recommended actions.

### Step 23:

The terminal acquires driving-behavior data from motion sensors and computes driving-pattern statistics.
Input: Raw acceleration and angular-velocity measurements over time.
Output: Statistical information describing the driving pattern.
The terminal samples inertial sensors at high frequency, detects events such as harsh braking and sharp turns by comparing features to thresholds, and aggregates event counts, average speeds, and continuous driving time into a set of statistics for a given driving interval.

### Step 24:

The server receives the driving-pattern statistics and creates a safe-driving prompt sentence.
Input: Driving-pattern statistics from the terminal.
Output: A safe-driving prompt sentence for the generative AI model.
The server expresses the statistics in simple natural language and appends instructions for generating concise advice, for example:
“Driving metrics for the last 120 minutes: There were 15 instances of strong braking, most of them at speeds above 50 kilometres per hour, the estimated following distance has been approximately one second, and the driving time without a break has been 120 minutes.
The task: Produce three short, concrete safety tips addressed directly to the driver using ‘you’ and avoiding technical terms, focusing on practical suggestions for safer driving.”

### Step 25:

The server obtains personalized safe-driving guidance from the generative AI model and sends it to the terminal.
Input: Safe-driving prompt sentence.
Output: One or more short safe-driving advice sentences.
The server processes the prompt through the generative AI model, obtains text output containing tailored tips, may remove extraneous content or enforce a maximum number of sentences, and transmits the guidance text to the terminal in a compact format.

### Step 26:

The terminal presents the safe-driving guidance to the user.
Input: Safe-driving advice sentences.
Output: Audio and/or visual presentation of personalized safety tips.
The terminal displays the tips on the display and/or synthesizes them to speech and plays them over the loudspeaker, providing the user with immediate, individualized feedback on driving behavior.

### Step 27:

The terminal receives follow-up commands from the user and requests route or guidance updates.
Input: User voice instructions or touch inputs (for example, “Add a gas station on the way” or “Avoid highways”).
Output: Updated requests containing new constraints and preferences sent to the server.
The terminal captures new utterances, recognizes them into text, associates them with the current route context, or interprets touch gestures on the display, and builds update messages that encode additional constraints or new destinations, which are then transmitted to the server to trigger recalculation.

### Step 28:

The server recomputes navigation and guidance based on updated user commands and system conditions.
Input: Update messages containing new constraints, vehicle state, and driving-pattern context.
Output: Updated travel routes, guidance information, and, when appropriate, additional explanation or advice.
The server merges the new constraints into the structured information, may generate new prompt sentences when further clarification or explanation is needed, recalculates routes or stopping points as required, and returns updated guidance to the terminal, thereby closing the control loop between the generative AI model, the navigation engine, and the in-vehicle user interface.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional navigation systems typically employ fixed-rule natural language understanding and static routing logic that are executed on computer processors. Such systems are constrained by pre-defined grammars, limited intent categories, and inflexible route evaluation criteria. As a result, when these systems are executed on general-purpose computing hardware, they often exhibit inefficient use of processing resources, redundant network interactions, and repeated failure-and-retry cycles in intent resolution and route selection. This leads to increased processor load, latency in generating navigation guidance, and suboptimal utilization of memory and communication bandwidth.

In particular, in existing architectures, destination inference and route selection are performed independently of accumulated user interaction history, and without dynamically adapting the internal control logic of the processor. Even when user preferences are stored, they are typically applied as static parameters or configuration flags. The processor is therefore required to execute multiple disjoint modules for heuristic disambiguation, preference handling, and route scoring, leading to fragmented processing pipelines, unnecessary data conversions, and duplicated computations. These limitations degrade overall system throughput and responsiveness, while also increasing the complexity of the software stack.

Moreover, conventional systems do not exploit generative artificial intelligence models as integrated control components for intent supplementation and route evaluation. When such models are used at all, they tend to be employed as external add-ons, invoked in an ad hoc manner without a structured prompt design or systematic feedback loop. In these configurations, the processor must execute additional glue code, repeated mappings between internal data structures and model inputs/outputs, and inconsistent caching strategies, thereby increasing memory pressure and processing time. The lack of a unified prompt-based control mechanism prevents the system from efficiently refining internal navigation decisions and reduces the predictability and stability of the computational behavior.

Additionally, traditional systems generally treat user interaction logs, route changes, and safety evaluations as passive records that are not tightly coupled to the runtime decision pipeline. As a consequence, the processor does not adapt its future control flows based on accumulated behavior data in a granular way. This leads to repeated evaluation of similar routing scenarios and repeated disambiguation of similar utterances, causing unnecessary computation and network usage. The inability to treat history information and preference information as first-class inputs to a generative control layer limits the achievable personalization and constrains the efficiency of the computational process.

Accordingly, there is a need for a technical solution that improves the way a processor executes navigation-related computation by (i) integrating generative AI models through well-defined prompt sentences as part of the core control logic, (ii) using history information, preference information, and situation information as structured inputs to these models, and (iii) feeding back user operations and safety evaluations into the prompt generation logic. Such a solution should reduce redundant computation, streamline data flows, and improve the processor's effectiveness in resolving user intent and selecting routes, thereby enhancing the overall performance, scalability, and resource efficiency of the computer-based navigation system.

The specific processing by the specific processing unit 290 of the data processing device 12 in Application Example 1 is realized by the following means.

The present invention provides a server comprising a processor and a memory storing instructions that, when executed by the processor, cause the processor to acquire and pre-process audio information from a user, convert the audio information into character information, extract intention information and target information from the character information, generate and transmit a prompt sentence to a generative information processing model together with situation information to obtain response information that supplements the intention information and the target information, acquire position information and route information and generate and evaluate a plurality of movement route candidates based on the supplemented intention information and target information, acquire history information and preference information for each user and generate and transmit another prompt sentence to the generative information processing model in order to obtain route evaluation indices, dynamically set evaluation conditions for the plurality of movement route candidates based on response information from the generative information processing model to select an optimal route, generate guidance information based on the optimal route and present the guidance information to the user as audio information and display information, and acquire operation information and route change information from the user, record the operation information and the route change information as the history information and the preference information, and store the operation information and the route change information as learning information for updating generation conditions of the prompt sentence for the generative information processing model. This enables the processor to execute an integrated, prompt-driven control pipeline in which intent resolution, route evaluation, and personalization are coordinated through the generative information processing model, thereby reducing redundant computations, improving utilization of memory and communication resources, and enhancing the overall computational efficiency and responsiveness of the navigation system.

The term “audio information” refers to digital data representing sound captured from a user or an environment, including but not limited to sampled waveforms of spoken utterances used for recognition and guidance generation.

The term “pre-process” refers to performing one or more computational operations on raw data to normalize, filter, segment, or otherwise condition the data for subsequent processing, including but not limited to noise reduction, level adjustment, and feature extraction.

The term “character information” refers to data representing text in a machine-readable format, including but not limited to sequences of encoded characters obtained by converting audio information into textual form.

The term “intention information” refers to data representing a semantic purpose or requested action inferred from user input, including but not limited to navigation requests, route modification requests, or preference expressions.

The term “target information” refers to data representing one or more objects or destinations associated with a user's intention, including but not limited to geographic locations, points of interest, or categories of facilities.

The term “situation information” refers to data representing a current or predicted context in which processing is performed, including but not limited to time, location, traffic conditions, environmental conditions, and system state.

The term “prompt sentence” refers to structured data including textual content that is generated to query a generative information processing model, the structured data specifying at least part of the intention information, target information, situation information, history information, or preference information to control operation of the model.

The term “generative information processing model” refers to a computational model that generates output data in response to input data, including but not limited to machine learning models configured to perform sequence generation, text completion, or structured output creation based on prompt sentences.

The term “response information” refers to data generated by the generative information processing model in response to a prompt sentence, including but not limited to supplemented intention information, supplemented target information, or route evaluation indices.

The term “position information” refers to data indicating a physical location, including but not limited to coordinates in a geographic reference system and associated metadata such as accuracy or timestamp.

The term “route information” refers to data describing one or more paths between two or more positions, including but not limited to sequences of waypoints, road segments, and associated attributes.

The term “movement route candidate” refers to data representing a possible path for movement between a starting position and a destination, including but not limited to a sequence of positions with associated costs or scores.

The term “history information” refers to data representing past interactions or states associated with a user or a system, including but not limited to previously selected routes, accepted or rejected suggestions, and past commands.

The term “preference information” refers to data indicating tendencies or choices favored by a user, including but not limited to preferences for scenic routes, avoidance of certain road types, or tolerance for travel time.

The term “route evaluation index” refers to a metric or set of metrics used to evaluate a movement route candidate, including but not limited to scores or weights related to travel time, distance, safety, or scenic quality.

The term “evaluation condition” refers to one or more rules, parameters, or weights used to compute at least one route evaluation index for a movement route candidate.

The term “optimal route” refers to at least one movement route candidate selected based on one or more evaluation conditions and route evaluation indices as being preferred relative to other candidates under given constraints.

The term “guidance information” refers to data used to inform a user of navigation actions, including but not limited to textual instructions, audio prompts, and visual indicators related to an optimal route.

The term “operation information” refers to data representing user interactions with a system, including but not limited to touch inputs, voice commands, confirmations, cancellations, and selection of options.

The term “route change information” refers to data indicating a modification to an existing route, including but not limited to a new destination, a requested detour, or a change in route characteristics.

The term “learning information” refers to data stored for use in training, adapting, or updating one or more models or algorithms, including but not limited to history information, preference information, and feedback data derived from operation information and route change information.

The term “generation conditions of the prompt sentence” refers to one or more rules, parameters, or templates that control how a prompt sentence is constructed from available information, including but not limited to selection, formatting, and weighting of input elements supplied to the generative information processing model.

The term “vehicle state information” refers to data representing a condition or status of a vehicle, including but not limited to fuel level, tire pressure, engine state, and system diagnostics.

The term “driving behavior information” refers to data representing movement or control actions of a vehicle, including but not limited to acceleration patterns, braking events, steering behavior, and speed profiles.

The term “evaluation information relating to safety” refers to data indicating an assessment of driving safety derived from vehicle state information and driving behavior information, including but not limited to risk scores, detected hazardous events, or safety level classifications.

The term “advice information” refers to data representing recommended actions or cautions presented to a user based on evaluation information, including but not limited to suggestions for safer driving behavior or maintenance actions.

The term “traffic information” refers to data describing conditions on transportation networks, including but not limited to congestion levels, incidents, closures, and travel speeds.

The term “environment information” refers to data describing physical or contextual conditions in an area, including but not limited to weather, visibility, road surface conditions, and environmental restrictions.

The term “external information source” refers to a system or service outside a local device or local network that provides information via a communication interface, including but not limited to remote servers, databases, or sensor networks.

The term “communication line” refers to a medium or facility for transmitting data between devices or systems, including but not limited to wired links, wireless links, and network connections.

In one embodiment, the system is implemented in an autonomous vehicle that includes a terminal and communicates with a server over a wireless network. The terminal comprises an in-vehicle computing unit, a high-sensitivity microphone, a loudspeaker, a display device, a positioning unit including a global positioning receiver and an inertial measurement unit, and an in-vehicle communication interface. The server comprises one or more processors, a main memory, a non-volatile storage device, and a network interface, and is connected to external information sources such as traffic information providers and map databases.

The terminal executes an operating system such as an embedded operating system, an automotive operating system, or a general-purpose operating system (for example, a Linux-based platform, a mobile operating platform, or a real-time operating platform), and runs an application program that implements audio acquisition, audio pre-processing, automatic speech recognition, user interface rendering, and communication with the server. The server executes an operating system such as a server operating system, and runs application programs and services that implement natural language processing, interaction with a generative AI model, route computation, data logging, and model training.

The terminal uses the high-sensitivity microphone and an audio interface subsystem (for example, an audio driver stack analogous to a general audio API) to acquire audio information from the user. The terminal samples the audio at a fixed sampling rate (for example, 16 kilohertz, 16-bit linear PCM) and stores frames of raw samples into a ring buffer in memory. The terminal executes a noise reduction algorithm on each frame. In one embodiment, the terminal performs spectral subtraction by applying a fast Fourier transform to each frame, estimating a noise spectrum from non-speech frames detected by a voice activity detector, subtracting the noise spectrum from the current frame spectrum, and applying an inverse fast Fourier transform. In another embodiment, the terminal applies a Wiener filter or a neural network-based denoiser.

The terminal converts the pre-processed audio information into character information using an automatic speech recognition engine. The terminal may use a hybrid model that combines an acoustic model and a language model, or an end-to-end model based on a sequence-to-sequence neural network. In one embodiment, the acoustic model is a deep neural network such as a bidirectional recurrent neural network or a transformer-based encoder that maps sequences of acoustic feature vectors (for example, Mel-frequency cepstral coefficients or log Mel-spectrograms) into sequences of probability distributions over phonetic units. The terminal extracts acoustic features by computing short-time Fourier transforms, applying Mel-filter banks, and performing logarithmic compression. The terminal passes the feature sequences to the acoustic model stored in memory.

The terminal uses a decoding algorithm such as a beam search decoder that combines the acoustic model output and a language model to produce text. The language model may be an n-gram model or a recurrent or transformer-based model that predicts token sequences. In an end-to-end configuration, the terminal may employ a connectionist temporal classification loss in training and a greedy or beam search decoding in inference. The terminal outputs character information as a sequence of encoded characters in a standard character encoding and associates metadata such as detected language, confidence scores, and timestamps.

The terminal maintains the character information and associated metadata in a structured data object in memory, and transmits the object to the server using a communication stack over a wireless connection. The terminal uses a transport protocol such as a reliable transport protocol over an Internet protocol, and secures the connection using an encryption protocol such as a transport layer security protocol. The terminal may batch multiple requests or compress payloads to reduce communication load. This reduces the number of redundant transmissions and improves communication efficiency.

The server receives the character information and parses it into an internal representation. The server executes a natural language processing module implemented using a natural language processing library (for example, a tokenization and parsing library or a transformer-based language processing library). The server tokenizes the character information into tokens or sub-word units, applies part-of-speech tagging, and performs syntactic parsing to obtain dependency relations. The server applies an intent classification model implemented as a neural network classifier that outputs one of several predefined intent categories such as navigation request, route modification request, or preference declaration.

The server determines target information by performing named entity recognition. The server uses a sequence labeling model (for example, a conditional random field model or a neural sequence labeling model such as a bidirectional recurrent layer with a conditional random field output layer) to identify entities related to geographic locations, facility types, and constraints such as “nearest” or “scenic.” The server combines the intent classification output and the named entity recognition output into intention information and target information. In parallel, the server collects situation information that includes current vehicle position, time, current traffic level, weather conditions, and current system state obtained from internal and external sources.

The server then interacts with a generative AI model. In one embodiment, the server uses a transformer-based generative model that includes multiple layers of self-attention and feed-forward sublayers, trained on text and structured navigation-related data. The generative AI model may be stored on the same hardware as the server or on separate computation hardware, and the server accesses the model via an application programming interface. The server maintains a prompt generation module that constructs a prompt sentence as a plain text string.

The prompt generation module arranges fields such as the user's utterance, the extracted intention information and target information, the situation information, the user's history information, and the user's preference information into a predetermined textual template.

In one example, the server generates a prompt sentence such as:
“From the following user utterance and context, identify the most likely navigation intent and destination constraints. Utterance: ‘I want to go to the nearest museum in the city.’ Current GPS: (35.68, 139.76). Output the intent type, place type, distance constraint, and area scope in a concise form.”

In another example, the server generates a prompt sentence such as:
“Based on the passenger's past preference data (frequent choices of scenic coastal roads, avoidance of highways, acceptance of slightly longer travel times) and the current request to navigate from the current position to a museum in the city, propose routing preference weights for scenic_score, time, distance, and avoid_highways.”

The server encodes the prompt sentence as character information and transmits it to the generative AI model. The generative AI model receives the prompt sentence and processes it using its internal transformer architecture. The model applies an embedding layer to convert tokens into vectors, performs multiple layers of self-attention using learned weight matrices, and applies non-linear transformations in feed-forward layers. During inference, the model computes probability distributions over output tokens at each time step and generates an output sequence using a decoding strategy such as greedy decoding or beam search with a temperature parameter.

The generative AI model outputs response information as text, which may represent structured content such as key-value pairs for intent type, place type, or weights for route evaluation indices. The server parses the response information by applying pattern matching or a lightweight parser and converts it into an internal structured representation. The server then merges this representation with previous intention information, target information, history information, and preference information. This integration allows the server to supplement incomplete or ambiguous user input and to compute dynamic evaluation conditions that are not fixed in advance.

The server uses the supplemented intention information and target information to access a map database or an external map service. The server issues a query that includes place type, distance constraints, and area scope, and receives candidate geographic positions and attributes. The server stores these candidates in a data structure such as a list or graph, where each candidate includes coordinates, type, and relevance score. The server also obtains traffic information and environment information from external information sources using communication lines, and associates this information with segments of a road network graph stored in a route computation module.

The server constructs movement route candidates by running a routing algorithm on the road network graph. In one embodiment, the server uses a graph search algorithm such as Dijkstra's algorithm, an A* search algorithm, or a contraction hierarchy-based algorithm to compute multiple candidate paths between the current position and each candidate destination. The server attaches attributes to each edge of the graph, such as length, expected travel time, congestion level, and scenic value derived from map attributes (for example, proximity to water bodies, parks, or viewpoints). The server calculates base evaluation indices for each movement route candidate, such as estimated time, distance, and base scenic score.

The server then applies route evaluation indices obtained via the generative AI model. The server uses response information that may specify weights or penalties such as “scenic_score: 0.8, time: 0.5, distance: 0.4, avoid_highways: true.” The server formulates a cost function in which a total cost for each candidate route is computed as a weighted sum or a multi-objective aggregation of time, distance, and negative scenic score, subject to constraints such as avoidance of certain road types. The server updates edge costs in the graph or applies a second-stage evaluation step to rank candidate routes according to these weights.

By computing routes in this manner, the server modifies the behavior of the routing algorithm dynamically based on model-generated evaluation indices instead of applying static rules. This yields technical effects such as reduced need for recomputation when user preferences change, improved convergence to a suitable route candidate, and reduced average processing time to obtain a route that the user is likely to accept. The server avoids repeated trial-and-error route generation by using the generative AI model to shape the evaluation conditions in advance.

The server selects an optimal route according to the weighted evaluation indices and stores it as a structured route object, including an ordered list of waypoints, corresponding road segments, maneuvers, and timing information. The server generates guidance information in the form of textual instructions and numerical values indicating distances and times. The server may generate instructions using predefined templates filled with route-specific parameters.

The terminal receives the guidance information and the route object from the server via the communication interface. The terminal stores the route in memory and uses a graphics rendering library (for example, a two-dimensional or three-dimensional graphics library) to display a map view with the route overlaid. The terminal uses position information from the positioning unit and integrates it with the route object to update a position marker on the map in real time. The terminal uses a text-to-speech engine deployed locally or accessed via the server to synthesize spoken guidance instructions. The terminal outputs the synthesized audio through the loudspeaker. Because the route has been pre-optimized using user-specific evaluation indices, the number of route corrections and server round-trips is reduced, which reduces communication load and improves responsiveness.

The server and the terminal jointly maintain history information and preference information. The terminal records operation information such as user touch interactions, acceptance or rejection of suggested routes, and explicit requests such as “choose a more scenic route” or “avoid highways.” The terminal summarizes this operation information and transmits it periodically to the server. The server aggregates this data into history information associated with user identifiers. The server updates preference information by applying statistical analysis or a simple machine learning model (for example, a logistic regression model or a small neural network) that infers preference parameters from repeated choices.

The server uses history information and preference information not only for generating prompt sentences but also for training or fine-tuning the generative AI model. In one embodiment, the server stores training examples consisting of prompt sentences and desired responses derived from actual user behavior. The server trains the generative AI model using a gradient-based optimization algorithm such as stochastic gradient descent or an adaptive optimizer. The server defines a loss function such as a cross-entropy loss between the model's predicted token distributions and the target tokens. The server updates model weights by backpropagation, computing gradients of the loss with respect to each parameter and applying weight updates.

The server may perform data augmentation by synthesizing additional training prompts that slightly vary phrasing, context, or preference patterns, thereby improving model robustness. The server may also adjust model hyperparameters such as learning rate, batch size, and number of training epochs. By systematically training the generative AI model on navigation-specific prompts and responses, the server improves the model's ability to output concise and structurally consistent response information that can be parsed deterministically by the server, reducing the risk of unstructured outputs and parse failures.

The server uses a prompt generation rule set that is stored as a configuration and updated based on learning information. For example, the server may emphasize certain fields in the prompt sentence (such as traffic information or recent preference changes) when it detects that past prompts produced ambiguous outputs. This constitutes a non-conventional, prompt-based control technique in which the generative AI model is treated as part of the decision pipeline rather than as an external oracle. The server thereby improves the internal behavior of the computer system: the natural language interpretation, route evaluation, and personalization components cooperate through defined text interfaces instead of loosely coupled APIs, leading to more deterministic flows and reduced error handling overhead.

The use of the generative AI model and prompt sentences in this system is not a mere automation of human decision-making. The server and the terminal implement specific data structures, parsing logic, and routing algorithms that are adapted to the model's outputs, and use feedback from the model to reconfigure computational pipelines. For example, when the model suggests a higher weight for scenic_score based on recent user choices, the server directly modifies cost coefficients in the route computation module and bypasses invocation of legacy heuristic rules.

This reduces the number of conditional branches executed by the processor and leads to more predictable performance characteristics. Furthermore, because the generative AI model can compress complex preference profiles and context into a compact set of evaluation indices, the amount of data that needs to be transmitted between components and stored in memory is reduced, improving memory usage and bandwidth efficiency.

The system also improves accuracy compared to conventional rule-based systems. The combination of conventional natural language processing, generative AI-based supplementation, and history-based adaptation reduces error cases where ambiguous phrases cannot be resolved.

The server measures acceptance rates of suggested routes and adjusts the model and prompt templates accordingly. As a result, the system converges to behavior that requires fewer retry cycles per user query, reducing processor usage and latency. The explicit integration of traffic information and environment information into prompt sentences allows the generative AI model to generate evaluation indices that reflect current conditions, further improving route selection quality.

In an alternative embodiment, the generative AI model may run partially on the terminal, for example as a smaller distilled model that handles local disambiguation or preference inference when connectivity is weak. In this embodiment, the terminal stores a reduced-size transformer network and prompt templates for frequently occurring commands. The server may still run a larger model for more complex cases. The system may also support multiple generative AI models, where one model specializes in intent supplementation and another in route evaluation.

The server can select models dynamically based on task type.

In another embodiment, the system applies similar concepts to non-vehicle environments, such as pedestrian navigation or robotic movement in an indoor facility. The terminal may be a handheld device, a wearable device, or a robot controller, and the server may incorporate building-specific maps and sensor data. The underlying architecture—where the server constructs prompt sentences including intention information, target information, situation information, history information, and preference information, and uses outputs of a generative AI model to modify internal evaluation conditions—remains similar and continues to provide technical benefits such as improved routing efficiency and adaptive decision-making.

By organizing the system in this manner, the server and the terminal cooperate to realize a navigation control architecture that integrates a generative AI model into the core control loop.

The server uses prompt sentences as explicit control signals, ensures that model outputs are mapped into specific data structures used by the routing engine, and updates model behavior using learning information derived from user interactions. This design results in improvements in processing speed, accuracy of intent resolution and route selection, and overall resource efficiency of the computer-based navigation system.

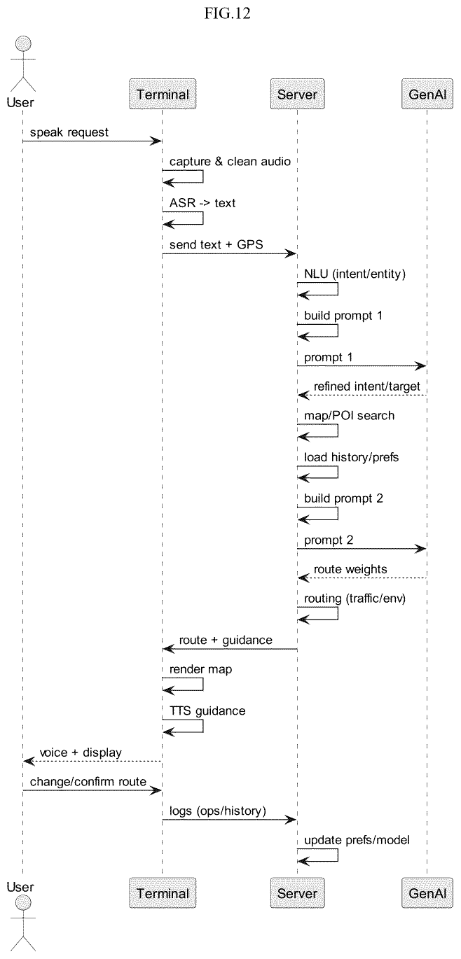

The following describes the processing flow using FIG. 12.

### Step 1:

The user utters a navigation-related command inside a vehicle, such as “I want to go to the nearest museum in the city” or “Please choose a more scenic route.”
The input in this step is acoustic sound pressure variation produced by the user.
The output in this step is analog audio captured at the microphone terminals of the terminal.
The terminal converts the analog signal into digital samples using an audio codec, samples the audio at a predetermined sampling frequency (for example, 16 kHz) and bit depth (for example, 16-bit PCM), and stores successive sample frames in an input audio buffer in memory.

### Step 2:

The terminal performs audio pre-processing on the buffered audio frames.
The input in this step is raw digital audio frames stored in the input audio buffer.
The output in this step is cleaned audio frames stored in a processed audio buffer, together with voice segment boundaries.
The terminal applies a voice activity detection algorithm to detect regions containing speech by computing short-term energy and zero-crossing rates or by using a small neural network classifier, and marks the start and end indices of the user's utterance.
The terminal performs noise reduction by transforming each frame into the frequency domain with a fast Fourier transform, estimating a noise spectrum from non-speech frames, subtracting the noise spectrum from speech frames, and converting the result back with an inverse fast Fourier transform.
The terminal normalizes the audio level to a target amplitude range and discards frames outside detected speech regions.

### Step 3:

The terminal executes automatic speech recognition to generate character information.
The input in this step is a sequence of cleaned audio frames representing the user's speech.
The output in this step is character information that encodes the recognized text, along with metadata such as language code and confidence scores.
The terminal computes acoustic feature vectors (for example, log Mel-spectrograms or Mel-frequency cepstral coefficients) from successive windows of the cleaned audio by applying windowing, fast Fourier transforms, Mel-filter banks, and logarithmic compression.
The terminal feeds the feature sequence into an acoustic model implemented as a neural network such as a transformer encoder or a bidirectional recurrent neural network, and obtains, for each time step, probability distributions over phonetic units or subword tokens.
The terminal combines the acoustic model outputs with a language model using a beam search decoder to compute the most probable token sequence, and converts that token sequence into encoded characters, thereby forming the recognized text.
The terminal attaches a language identifier, timestamp, and per-token confidence metrics and stores this as character information in a structured object.

### Step 4:

The terminal prepares a transmission object and sends it to the server.
The input in this step is the character information and associated metadata created by the terminal, plus current position information from the vehicle's positioning unit.
The output in this step is a structured request message transmitted over a network to the server and received by the server's network interface.
The terminal constructs a data object that includes recognized text, language code, current geographic coordinates, and a session identifier, and serializes this object into a message format such as JSON.
The terminal opens or reuses a secure transport connection using a transport protocol and an encryption protocol, writes the serialized message to a send buffer, and transmits the data over a wireless communication channel to the server.
The server receives the data at a network interface, validates the message structure and authentication credentials, and stores the message contents in an incoming request buffer.

### Step 5:

The server performs initial natural language processing to obtain preliminary intention information and target information.
The input in this step is the character information and metadata extracted from the request message by the server.
The output in this step is preliminary intention information and preliminary target information represented in internal data structures.
The server tokenizes the recognized text into tokens or subword units using a tokenizer and feeds the tokens into a natural language understanding module.
The server executes an intent classification model, such as a neural network classifier, that takes token embeddings as input and outputs an intent label (for example, navigation_request, route_modification, or preference_query).
The server executes a named entity recognition model, such as a sequence labeling model, that assigns labels to tokens to identify entities such as destination type, facility type, and modifiers like “nearest” or “in the city.”
The server aggregates the intent label and the extracted entities into preliminary intention information and preliminary target information and associates these with the user session.

### Step 6:

The server constructs a first prompt sentence for a generative AI model to refine intention information and target information.
The input in this step is the preliminary intention information, the preliminary target information, the original recognized text, and situation information including current position and time.
The output in this step is a prompt sentence as a text string that conforms to a predetermined template suitable for the generative AI model.
The server selects a prompt template for intent supplementation and fills template fields with values derived from the recognized text and the situation information.
The server, for example, generates a prompt sentence such as:
“From the following user utterance and context, identify the most likely navigation intent and destination constraints. Utterance: ‘I want to go to the nearest museum in the city.’ Current GPS: (35.68, 139.76). Output the intent type, place type, distance constraint, and area scope in a concise form.”
The server encodes this prompt sentence in a text format, records it in a prompt log for the session, and prepares it as input for the generative AI model.

### Step 7:

The server sends the first prompt sentence to the generative AI model and receives response information for intent supplementation.
The input in this step is the text-form prompt sentence generated in the previous step.
The output in this step is response information generated by the generative AI model, represented as text that encodes refined intention information and refined target information.
The server transmits the prompt sentence to the generative AI model through an application programming interface and waits for a response.
The generative AI model processes the prompt sentence using a transformer-based architecture with an embedding layer, multiple self-attention layers, and feed-forward layers, and decodes a sequence of output tokens corresponding to an answer.
The server receives the textual response, which may be in a structured textual format such as “intent: navigate_to_place; place_type: museum; distance_constraint: nearest; area_scope: current city,” and stores this response in memory as response information.

### Step 8:

The server parses the response information and merges it with the preliminary intention information and preliminary target information.
The input in this step is the textual response information from the generative AI model and the preliminary intention information and preliminary target information previously determined by the server.
The output in this step is supplemented intention information and supplemented target information represented in internal structured data.
The server applies string parsing operations or pattern matching to extract key fields from the response information, mapping them to internal variables for intent type, place type, constraints, and scope.
The server compares the supplemented values with the preliminary values, resolves conflicts according to a precedence rule (for example, preferring explicit model outputs when confidence is high), and constructs final intention information and final target information.
The server stores these supplemented data structures in association with the session, and marks the intention resolution as complete.

### Step 9:

The server queries map and location services to obtain candidate destinations based on the supplemented target information.
The input in this step is the supplemented target information, which may include a place type such as “museum,” a distance constraint such as “nearest,” and an area scope such as “current city,” along with current position information.
The output in this step is a set of candidate destination entries containing geographic coordinates and descriptive attributes.
The server generates a query that includes the place type, a search radius derived from the area scope, and the current position, and sends the query to a map database or an external map service.
The server receives a list of candidate locations, each with coordinates, name, category tags, and sometimes ratings, and converts this list into internal destination objects.
The server filters out destinations that do not meet constraints (for example, outside the city boundary or not open at the current time) and sorts the remaining candidates by distance or relevance.

### Step 10:

The server retrieves history information and preference information for the user and constructs a second prompt sentence for route evaluation.
The input in this step is user-specific history information and preference information stored in a database, together with current origin and each candidate destination.
The output in this step is a second prompt sentence designed to obtain route evaluation indices from the generative AI model.
The server selects historical records related to previous route selections, scenic route requests, avoidance of certain road types, and tolerance to travel time, and aggregates these records into a concise preference profile.
The server then fills a route-evaluation prompt template with the preference profile and current navigation context.
The server, for example, generates a prompt sentence such as:
“Based on the passenger's past preference data (frequent choices of scenic coastal roads, avoidance of highways, acceptance of slightly longer travel times) and the current request to navigate from the current position to a museum in the city, propose routing preference weights for scenic_score, time, distance, and avoid_highways.”
The server stores the generated prompt sentence in a prompt log and uses it as input to the generative AI model.

### Step 11:

The server sends the second prompt sentence to the generative AI model and receives route evaluation indices.
The input in this step is the second prompt sentence describing preference data and current navigation context.
The output in this step is response information that encodes route evaluation indices such as weights for scenic_score, time, distance, and constraints like avoid_highways.
The server passes the prompt sentence to the generative AI model via the interface and waits for the model's output.
The generative AI model processes the input prompt with its neural network layers and produces an answer text such as “scenic_score=0.8, time=0.5, distance=0.4, avoid_highways=true.”
The server receives this text as response information and stores it as a structured object containing numeric values and boolean flags.

### Step 12:

The server converts the route evaluation indices into evaluation conditions for a routing engine.
The input in this step is the set of route evaluation indices produced by the generative AI model.
The output in this step is a set of evaluation conditions, including cost coefficients and constraints, used by the routing engine to compute and rank movement route candidates.
The server maps the scenic_score weight, time weight, and distance weight onto coefficients in a cost function such as C=w_time*T+w_distance*D−w_scenic*S, where T is estimated time, D is distance, and S is scenic score.
The server translates avoid_highways into a constraint that assigns a large penalty to road segments classified as highways in the road network graph.
The server stores these evaluation conditions in a configuration structure for the routing engine and marks them as active for the current session.

### Step 13:

The server generates movement route candidates and selects an optimal route according to the evaluation conditions.
The input in this step is the current origin position, the set of candidate destinations, the road network graph with traffic and environment information, and the evaluation conditions.
The output in this step is an optimal route represented as a sequence of waypoints, maneuvers, and timing information.
The server first updates edge attributes of the road network graph by incorporating current traffic information and environment information, adjusting travel time estimates or marking edges as blocked when necessary.
The server runs a graph search algorithm such as a modified A* algorithm that uses the cost function defined by the evaluation conditions to compute multiple candidate paths to one or more candidate destinations.
The server computes route evaluation indices for each candidate path (for example, total time, total distance, scenic score) and evaluates the cost function for each path, then selects the route with the lowest cost (or highest utility) as the optimal route.
The server constructs a route object that includes detailed turn-by-turn maneuvers, coordinates of waypoints, and estimated arrival times.

### Step 14:

The server generates guidance information based on the optimal route and sends it to the terminal.
The input in this step is the optimal route object selected by the server.
The output in this step is a guidance message set and route data transmitted to the terminal.
The server converts maneuvers and distances into human-readable instructions such as “Turn left in 300 meters” or “You will arrive at the museum in approximately 20 minutes,” and stores these strings in a list aligned with route waypoints.
The server packages the route polyline, maneuver list, estimated travel times, and associated instructions into a structured message, serializes it, and sends it to the terminal over the secure communication channel.
The terminal receives the message, validates its structure, and stores the route object and guidance messages in its local memory.

### Step 15:

The terminal renders the route and presents visual and audio guidance to the user.
The input in this step is the route object and guidance messages received from the server, together with current position information from the positioning unit.
The output in this step is a visual map display with the route overlaid and synthesized audio instructions played to the user.
The terminal requests map tiles or uses an internal map database to draw the background map, and overlays the route polyline and maneuver icons on the display.
The terminal updates the position of the user's vehicle icon on the display by combining positioning data with the route geometry.
The terminal selects the next guidance message based on the distance to the upcoming maneuver, passes the text of this message to a text-to-speech engine, receives synthesized audio samples, and outputs the audio through the loudspeaker.
The user observes the map and hears the spoken instructions and follows the suggested path in the physical environment.

### Step 16:

The terminal and the server update history information and preference information based on the user's behavior.
The input in this step is operation information and route change information generated during the navigation session, such as user-initiated reroutes, explicit requests (for example, “choose a more scenic route”), and acceptance or cancellation of suggestions.
The output in this step is updated history information and preference information stored in a database and learning information used to improve prompt sentence generation and generative AI model behavior.
The terminal records each relevant interaction event with timestamps and context and periodically sends summarized logs to the server.
The server aggregates the logs for each user, updates counts and statistics that represent tendencies (for example, frequency of scenic route requests or rate of avoiding highways), and updates stored preference parameters.
The server optionally uses the aggregated data as training or fine-tuning examples for the generative AI model and adjusts prompt templates or generation conditions to emphasize information that has proven useful in reducing future ambiguity and computation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional in-vehicle navigation and driving-assistance systems typically implement speech recognition, rule-based natural language interpretation, and route computation as separate and static software modules. These systems generally convert a driver's speech into text, extract a destination, and calculate an optimal route according to predefined cost functions that depend only on map data and traffic information. Likewise, conventional safety-advice functions rely on fixed thresholds applied to vehicle sensor signals, and output pre-authored warning messages when certain conditions are met. As a result, several technical problems arise.

First, because the processing pipeline treats speech content, sensor data, and any emotion-related signals independently, the system cannot adapt its internal control logic or data-processing parameters to a user's current emotional state. Even if voice prosody or textual sentiment suggests irritation, anxiety, or fatigue, the navigation engine continues to execute route search based on fixed weights for travel time, congestion, tolls, or hazardous segments. This rigid architecture limits the system's ability to dynamically adjust graph-search costs, evaluation metrics, or guidance frequency in a way that matches the user's cognitive load or stress level. Consequently, the overall human-machine interface can increase driver distraction and does not fully leverage available multimodal data.

Second, integrating emotion information into a navigation system using conventional approaches requires bespoke, hand-crafted rules that are difficult to scale and maintain. When the number of possible combinations of emotion labels, vehicle states, and driving behaviors grows, rule-based control logic becomes complex and fragile. Updating such logic to handle new driving patterns, sensor types, or nuanced emotional contexts demands extensive software modifications and redeployment. This leads to poor maintainability and impedes continuous improvement of in-vehicle software.

Third, known systems do not systematically exploit generative AI models through structured prompt sentences as internal computation modules. Generative models are often used only as peripheral chatbots, with the navigation core remaining unchanged. In such designs, outputs from generative models are loosely coupled free-form texts, which are not reliably fed back into core routing or guidance-control algorithms. Without a disciplined prompt design and structured post-processing, it is difficult for the computing platform to use generative models as deterministic subroutines that produce machine-usable parameters, such as integrated emotional states, route policies, or presentation styles. This leads to inconsistent behavior, unpredictable latency, and incompatibility with real-time requirements.

Fourth, existing systems generally do not maintain a unified, user-specific history that combines emotional state estimates, route decisions, sensor-derived driving behavior, and system responses. Without such structured historical context, the system cannot systematically refine prompts or model parameters per user, nor can it adapt guidance style, output timing, or safety thresholds over time. This absence of longitudinal personalization at the system level prevents the processor from learning stable user preferences, and results in repetitive or ill-timed guidance that can degrade usability and acceptance.

Accordingly, there is a need for a computer-implemented in-vehicle system that: (i) tightly integrates speech recognition, multimodal emotion estimation, and route computation in a single processing architecture; (ii) uses a generative AI model, driven by precisely constructed prompt sentences, as a controllable internal component that outputs structured parameters used directly by core algorithms; (iii) dynamically adjusts cost functions, evaluation weights, and output modalities of navigation and safety components based on an integrated emotional state; and (iv) maintains and exploits user-specific history to automatically refine prompt contents and guidance styles, thereby improving the technical performance, adaptability, and maintainability of the navigation and driving-assistance software stack.

The specific processing by the specific processing unit 290 of the data processing device 12 in Example 2 is realized by the following means.

The present invention provides a server comprising a processor and a memory storing instructions that, when executed by the processor, cause the processor to perform operations including: receiving acoustic data from an in-vehicle terminal and converting the acoustic data into text data by executing a speech recognition process; analyzing the text data by executing a natural language processing process to identify a user intention; extracting, from the acoustic data, emotion recognition features including at least a fundamental frequency value, an energy value, a speech rate value, a silence duration value, and a spectral characteristic value; generating a first prompt sentence that describes the text data and the emotion recognition features together with a required output format for an emotional state and a support policy; inputting the first prompt sentence into a generative AI model and obtaining, as a structured output, integrated emotional state information representing an emotional state of the user and support policy information representing a control policy of the system; accessing geographic spatial data and traffic state information stored in one or more data stores; executing a route search process on a road network graph to generate optimal route information between a current position and at least one candidate destination, the route search process including changing evaluation criteria or link costs of the road network graph in accordance with at least the integrated emotional state information and the support policy information; generating a second prompt sentence that describes the optimal route information, the integrated emotional state information, and presentation constraints; inputting the second prompt sentence into the generative AI model and obtaining, as a structured output, guidance message text that is adapted to the emotional state of the user; and transmitting the optimal route information and the guidance message text to the in-vehicle terminal to control at least one of a voice guidance output and a visual guidance output. This enables the in-vehicle system to use the generative AI model as a deterministic computational component that, through controlled prompt sentences, dynamically influences graph-based route computation, cost-function weighting, and multimodal guidance generation based on integrated emotional state information, thereby improving the adaptability, efficiency, and maintainability of the underlying computer-implemented navigation and driving-assistance processes.

The term “acoustic signal” refers to an analog or digital representation of sound pressure variations received from an input transducer, including at least speech produced by a user in a vehicle cabin.

The term “speech recognition function” refers to a computer-implemented process that transforms an input acoustic signal into text data representing linguistic content, typically by extracting acoustic features and applying a statistical or neural recognition model.

The term “text data” refers to digital character data representing linguistic content of user speech, suitable for processing by natural language processing algorithms.

The term “natural language processing function” refers to a computer-implemented process that analyzes text data to derive structured information, such as user intentions, semantic labels, or emotion-related attributes.

The term “user intention” refers to information indicating a target action or goal inferred from user input, such as a desired destination, route condition, or request type in a navigation context.

The term “generative AI model” refers to a machine learning model that has been trained on large-scale data to stochastically generate output data, such as text, in response to input context, including prompt sentences and auxiliary features.

The term “prompt sentence” refers to a text instruction provided as input to a generative AI model, the text instruction specifying at least a processing objective, an expected output format, and one or more pieces of contextual data.

The term “emotion recognition features” refers to numerical descriptors computed from an acoustic signal, including at least fundamental frequency, energy, speech rate, silence duration, and spectral characteristics, which are used to estimate an emotional state of a user.

The term “emotion recognition feature vector” refers to a set of one or more emotion recognition features encoded as structured numerical data for processing by a computing device.

The term “fundamental frequency value” refers to a numerical descriptor representing a dominant periodic component of a voiced segment in an acoustic signal.

The term “energy value” refers to a numerical descriptor representing a magnitude of signal power within a specified time window of an acoustic signal.

The term “speech rate value” refers to a numerical descriptor representing a temporal density of spoken units, such as syllables or words, within a given duration of a speech signal.

The term “silence duration value” refers to a numerical descriptor representing a time length of non-voiced or low-energy intervals between voiced segments in a speech signal.

The term “spectral characteristic value” refers to a numerical descriptor derived from a frequency-domain representation of an acoustic signal, such as spectral centroid, spectral slope, or bandwidth.

The term “text emotion analysis result” refers to information obtained by applying a text-based emotion classification process to text data, the information including at least an emotion label and one or more scores for emotion categories.

The term “integrated emotional state information” refers to data representing a unified estimate of a user's emotional state, obtained by combining the emotion recognition features and the text emotion analysis result, and optionally including an intensity value and categorical labels.

The term “emotional state” refers to a classification or parameterization of a user's affective condition, including but not limited to irritation, anxiety, calmness, or fatigue, optionally associated with a numerical intensity.

The term “support policy” refers to control parameters or rules derived from the integrated emotional state information, which specify how system components such as route calculation, timing of messages, and presentation style should be adjusted.

The term “geographic spatial data” refers to digital data describing geographic entities, including locations of roads, junctions, and facilities, expressed in one or more spatial coordinate systems.

The term “traffic state information” refers to digital data describing dynamic conditions of a road network, including congestion levels, incidents, road closures, and other factors that affect travel time.

The term “road network graph” refers to a data structure representing a road network as nodes and links, where nodes correspond to intersections or points of interest and links correspond to road segments.

The term “link cost” refers to a numerical value associated with a link in a road network graph, representing an expense measure such as expected travel time, distance, or risk for traversing the link.

The term “candidate destination” refers to a location selected from geographic spatial data as a potential target endpoint for route calculation based on user intention and search conditions.

The term “route search process” refers to a computational procedure that determines one or more paths in a road network graph between two or more points under a defined cost function.

The term “optimal route information” refers to data specifying at least one route selected as best under a given evaluation criterion, and including route geometry, maneuver points, and estimated travel time.

The term “evaluation criteria” refers to rules or cost functions used to compare multiple route candidates, based on parameters such as travel time, congestion penalty, toll cost, or hazardous segment penalty.

The term “guidance message text” refers to digital text that describes navigation or driving instructions intended to be presented to a user via voice or display output.

The term “voice guidance output” refers to an audio signal generated by a speech synthesis process based on guidance message text and output via one or more speakers.

The term “visual guidance output” refers to graphical or textual information rendered on a display, including route maps, maneuver icons, and explanatory text derived from guidance message text.

The term “vehicle state information” refers to data obtained from one or more vehicle-mounted sensors indicating operational status, including at least fuel level, tire pressure, power system status, and braking system status.

The term “driving behavior information” refers to data derived from one or more motion-related sensors indicating driving operations, including at least acceleration, angular velocity, and sudden operation events such as abrupt braking or steering.

The term “state detection sensor” refers to a sensor configured to detect a physical or operational state of a vehicle component, such as a fuel sensor, a pressure sensor, or a temperature sensor.

The term “behavior detection sensor” refers to a sensor configured to detect motion or orientation of a vehicle, such as an accelerometer or a gyroscope.

The term “sudden operation event” refers to a driving behavior event detected when a measured physical quantity, such as deceleration or steering angle rate, exceeds a predetermined threshold.

The term “history data” refers to stored information that associates integrated emotional state information, vehicle state information, driving behavior information, and system responses over time for a particular user.

The term “output style of a guidance message” refers to presentation parameters controlling how guidance is provided, including at least message length, tone, level of detail, frequency of messages, and layout for display.

The term “safe driving risk” refers to an evaluation result indicating a likelihood or degree of unsafe driving conditions, derived from vehicle information and integrated emotional state information.

The term “safe driving advice message” refers to guidance message text that is generated to encourage safer driving behavior, taking into account both vehicle-related risks and user emotional state.

The term “external information providing apparatus” refers to a computing system, accessible via a communication network, that supplies traffic state information, environmental state information, or other external data.

The term “environmental state information” refers to data representing environmental conditions that may affect driving, including at least weather, road surface conditions, and visibility.

The term “congestion section” refers to a link or group of links in a road network graph identified as having low traffic flow speed, high traffic density, or other indicators of congestion.

The term “toll section” refers to a link or group of links in a road network graph that require a monetary fee for passage.

The term “hazardous section” refers to a link or group of links in a road network graph that are associated with elevated risk, such as accident-prone zones, steep gradients, or adverse environmental exposure.

The term “evaluation weight” refers to a coefficient applied to a component of a cost function used to evaluate route candidates, the coefficient being adjustable based on integrated emotional state information and other factors.

In the following embodiments, a “terminal” denotes an in-vehicle information processing apparatus, a “server” denotes a remote information processing apparatus connected to the terminal via a network, and a “user” denotes a driver operating a vehicle. A generative AI model and prompt sentences are used as internal computational components that interact with conventional navigation and sensing functions.

### A. Overall Hardware and Software Configuration

Terminal includes at least one general-purpose processor, a memory, a non-volatile storage device, a microphone, a loudspeaker, a display panel, a vehicle communication interface, and motion sensors comprising at least an accelerometer and a gyroscope. Terminal executes an embedded operating system, a speech recognition engine, a digital signal processing library, a feature extraction library, a text-to-speech engine, a map rendering engine, and a communication client module.

Server includes one or more processors, a main memory, a mass storage device, and a network interface. Server executes an operating system, a web or RPC server, a natural language processing module, a generative AI model execution module, a geographical database, a traffic information acquisition module, a route computation module, a safety-evaluation module, and a history management module.

In one embodiment, terminal uses a real-time audio processing library (for example, an implementation equivalent to a WebRTC audio processing library) to perform noise suppression, echo cancellation, and voice activity detection. Terminal uses a speech recognition engine equivalent to a general-purpose open-source recognizer (for example, an engine comparable to Vosk) to convert speech to text. Terminal uses a feature extraction library equivalent to an openSMILE-type library to compute emotion recognition features. Server uses a transformer-based natural language model (for example, a model functionally similar to a BERT architecture) and a large language model as a generative AI model. These specific names are examples; other equivalent software components can be used.

### B. Audio Acquisition and Feature Computation

Terminal acquires an acoustic signal from the microphone as an analog voltage. Terminal samples and quantizes the signal to obtain pulse-code-modulated digital audio stored in memory. Terminal applies the digital signal processing library to segment the audio into frames, detect speech segments, and reduce background noise. Terminal computes a short-time Fourier transform for each frame and applies a mel filter bank and a discrete cosine transform to compute mel-frequency cepstral coefficients.

Terminal executes the speech recognition engine on the sequence of acoustic features, performing probabilistic decoding with an acoustic model and a language model to output text data representing the user's utterance. Terminal converts the text into a character sequence, such as “I want to get to the nearest shopping mall as quickly as possible, but I want to avoid traffic jams.”

Terminal, in parallel, applies the feature extraction library to the preprocessed audio to compute emotion recognition features. Terminal calculates, for each frame, a fundamental frequency value, an energy value, and spectral descriptors, and calculates global statistics such as mean, variance, maximum, and minimum over an utterance window. Terminal also estimates a speech rate value and a silence duration value by counting voiced frames and gaps. Terminal aggregates these values into an emotion recognition feature vector.

Terminal associates the emotion recognition feature vector with the recognized text and metadata (for example, time, vehicle identifier), and transmits both to the server via a secure network protocol.

This combined feature computation improves technical accuracy of emotion estimation because the server receives both fine-grained acoustic descriptors and textual content, allowing multi-modal fusion of cues, rather than relying on coarse labels alone.

### C. Text Analysis and Emotion Integration

Server receives the text data and the emotion recognition feature vector from the terminal. Server applies a tokenizer to the text data to convert it into token indices, and feeds the indices into a transformer encoder network. In one embodiment, the transformer encoder includes multiple self-attention layers, feed-forward sublayers, and positional encodings. Server obtains a pooled embedding vector representing the entire utterance and applies a dense layer with softmax activation to obtain text-based emotion probabilities for categories such as calm, irritated, anxious, and neutral.

Server combines the text-based emotion probabilities with the received acoustic emotion recognition features by constructing a prompt sentence for the generative AI model. Server, for example, generates the following prompt sentence:
“You are an emotion analysis engine for an in-vehicle system.
Based on the following information, infer the user's current emotional state (for example, calm, irritated, nervous, fatigued, anxious) and its intensity (0.0-1.0), and output a recommended support policy for a driving assistance system.

### [Audio Features]

Average fundamental frequency: 230 Hz
Variation of fundamental frequency: large
Average energy: high
Speech rate: faster than usual
Silence duration: short

### [Recognized Text]

‘I want to get to the nearest shopping mall as quickly as possible, but I want to avoid traffic jams.’

### [Text Emotion Scores]

Anger: 0.6
Anxiety: 0.3
Joy: 0.1

### Output:

1) Emotion label
2) Emotion intensity (0.0-1.0)
3) Recommended support policy (for example, prioritize earliest arrival time, make guidance concise, use calm tone).”

Server inputs this prompt sentence into the generative AI model. The generative AI model, in one embodiment, is a transformer-based decoder or encoder-decoder network with multiple attention layers, trained on large corpora of dialogues and instruction-response pairs. Server controls the model's decoding parameters, such as maximum token length and sampling temperature, to constrain the output.

Server receives the model output as text, for example:
“Emotion label: irritated
Emotion intensity: 0.75
Recommended support policy: prioritize the shortest arrival time and keep navigation instructions concise and calm.”

Server parses this output using a rule-based parser that searches for specific keywords and numeric patterns. Server converts the parsed values into integrated emotional state information (for example, a record including label “irritated,” intensity 0.75) and support policy information (for example, flags indicating “time_priority=high,” “concise_guidance=true,” “calm_tone=true”).

This architecture improves computer operation because the generative AI model is constrained by a domain-specific prompt sentence and its output is post-processed into deterministic structured parameters. The system does not rely on uncontrolled free-form text; instead, the server uses the model to implement a non-trivial mapping from heterogeneous numeric and symbolic inputs to control parameters that directly affect graph search and interface behavior. This mapping would be difficult to implement and maintain as traditional hand-coded rules.

### D. Intent Extraction and Route Policy Generation

Server further uses the generative AI model to extract navigation intent from the recognized text and the integrated emotional state. Server composes a second prompt sentence, for example:
“You are an intent analysis engine for a car navigation system.
Based on the following user utterance and emotional state, identify:
1) Destination type,
2) Search conditions,
3) Route selection policy.

### [User Utterance]

‘I want to get to the nearest shopping mall as quickly as possible, but I want to avoid traffic jams.’

### [Emotional State]

Label: irritated
Intensity: 0.75

### Output:

Destination type (for example, shopping mall)
Search conditions (for example, nearest from current position, with parking)
Route selection policy (for example, minimize travel time, avoid heavy congestion).”

Server inputs this prompt sentence into the generative AI model and receives a structured textual answer that server parses into intent fields. By using the same model with appropriately tailored prompt sentences, server unifies the extraction of user intention and emotion-aware route policy without adding specialized hand-coded logic modules.

This reuse of a single generative AI model with multiple prompt sentences reduces memory consumption and maintenance overhead, since server need not host separate specialized classifiers for every new behavior. It also allows server to modify system behavior by updating prompt templates stored as configuration data rather than recompiling code.

### E. Emotion-Aware Route Computation

Server accesses a geographical spatial database stored in a relational database management system with spatial extensions. Server stores road segments, intersections, and facilities as objects in a road network graph. Server stores traffic state information received from external providers as link attributes such as current speed, delay factor, or incident flags.

Server uses a routing engine to perform pathfinding on the road network graph. Server defines a cost function for each link that combines a base travel time with additional terms reflecting toll fees, congestion penalties, and hazard levels. Server modifies the weights of these terms based on the integrated emotional state and the support policy. For example, when the emotional state indicates strong irritation and high time priority, server increases a penalty term for congested links and decreases a penalty for tolled but faster links.

Server computes, for each candidate destination, multiple path candidates using a shortest-path algorithm such as Dijkstra or A* with heuristic estimates. Server evaluates each path using the emotion-adjusted cost function and selects the path with the lowest cost as optimal route information. Server encodes the optimal route as a sequence of nodes and links, each with associated maneuvers and timestamps, and transmits this information to terminal.

By adjusting link costs and evaluation weights at runtime, the server improves computational efficiency and user satisfaction. Instead of recomputing or reconfiguring the entire optimization engine, server injects emotional state parameters into the cost function, which is a continuous-valued structure easily handled by standard graph algorithms.

### F. Emotion-Adaptive Guidance Generation

Terminal receives the optimal route information and the integrated emotional state or policy flags. Terminal determines the next maneuver and estimated time of arrival. Terminal generates a prompt sentence for guidance message generation, for example:
“You are a conversation agent for an in-vehicle navigation system.
The user is currently in an ‘irritated’ state and wants to arrive as quickly as possible.
Based on the following route information and policy, create one concise guidance sentence with a calm tone that does not increase stress.

### [Route Information]

Next maneuver: turn right at the intersection 500 meters ahead
Estimated time of arrival: 15 minutes

### [Policy]

Briefly mention that arrival will be soon
Omit unnecessary explanations
Avoid commanding expressions.”

Terminal sends this prompt sentence to the server or to a local lightweight generative AI model.

Server or terminal obtains a guidance message text such as:
“If you turn right at the intersection 500 meters ahead, you will reach your destination in about 15 minutes.”

Terminal feeds this guidance message text into the text-to-speech engine. Terminal sets parameters such as speech rate, pitch, and volume based on the support policy. Terminal generates an audio waveform that is output by the loudspeaker. Terminal simultaneously renders a visual arrow and text on the display with font sizes and information density adjusted according to the emotional state.

These operations constitute a technical improvement over static, template-based message systems. The generative AI model generates diverse language that matches both route content and emotional policy, while the terminal ensures deterministic enforcement of length and tone constraints through prompt design and parameter checks. This reduces cognitive load for the user and can reduce the number of repeated or clarifying interactions, thereby reducing communication bandwidth and processing overhead.

### G. Safe Driving Evaluation and Advice

Terminal continuously acquires vehicle state information from the vehicle bus, including values representing fuel level, tire pressure, power system status, and braking system status. Terminal also acquires driving behavior information from motion sensors, such as instantaneous acceleration, angular velocity, and detected sudden operation events. Terminal aggregates these values over a fixed window to produce counts of hard braking, hard acceleration, and sharp steering.

Server or terminal evaluates a safe driving risk by applying threshold rules and statistical models to the aggregated values and the integrated emotional state. For example, server uses a weighted sum of normalized event counts and emotional intensity to compute a risk score. Server constructs a prompt sentence for the generative AI model, for example:
“You are a safe-driving advisor for an in-vehicle system.
Using the following information, create one short message that encourages safer driving while taking the driver's feelings into account.

### [Emotional State]

Label: irritated
Intensity: 0.8

### [Driving Behavior]

Hard accelerations in the last 10 minutes: 5
Hard brakings in the last 10 minutes: 4

### [Vehicle State]

Fuel remaining: 20%
Distance to next fuel station: 15 km

### Conditions:

Do not blame or scold the driver.
Include at least one reassuring phrase.”

Server or terminal inputs this prompt sentence into the generative AI model and receives a safe driving advice message such as:
“Your recent accelerations and braking have become a bit sudden; if you take it a little more slowly, your fuel will be sufficient, so let's continue driving calmly.”

Terminal outputs this advice as synthesized speech and displays it as text.

This embodiment enables a non-trivial combination of quantitative risk scores and qualitative, emotion-sensitive wording. Conventional rule-based systems would output fixed warnings; here, server leverages the generative AI model with prompt sentences to convert a risk profile into a natural yet constrained message, improving driver compliance and potentially reducing abrupt maneuvers.

### H. History Management and Personalization

Server maintains history data in a database, associating for each user a sequence of entries including emotion labels and intensities, vehicle states, driving behaviors, chosen routes, guidance messages, and user responses (for example, whether the user followed a suggestion or canceled a route). Server may periodically summarize this history to derive user preference parameters, such as typical tolerance for route length or preferred guidance frequency. Server can use the generative AI model to assist in summarizing complex histories. Server, for example, constructs a prompt sentence:
“You are a preference analysis engine for an in-vehicle system.
Based on the following interaction history for a single driver, summarize in three bullet points the preferred guidance frequency and wording style.
[History excerpt:
Repeatedly accepted concise guidance
Often ignored long explanations
Responded positively to safety advice at the end of trips
. . . ]”

Server receives a summary, such as:
“Prefers brief and calm navigation instructions.
Is more receptive to safety advice after arriving or near the end of a trip.
Tends to ignore excessive detail during periods of irritation.”

Server converts this summary into numeric parameters stored in the user profile, such as a maximum guidance length, preferred timing of safety messages, and default tone selection.

Server updates the prompt templates and cost function weights for future sessions based on these parameters.

This history-based adaptation improves computational efficiency and user experience: server reduces unnecessary model invocations and shortens prompts when long prompts are known to be less effective for a given user. It also reduces data storage and bandwidth by focusing on parameters rather than raw logs.

### I. Technical Effects and Computer-Technology Improvements

The described system improves computer technology in several ways:

Server and terminal use the generative AI model as a controlled computational component that outputs structured parameters affecting cost functions and presentation logic, rather than merely generating free-form text. Prompt sentences define explicit interfaces between traditional deterministic modules and the generative model, enhancing modularity and maintainability.

Server dynamically adjusts graph-search link costs based on integrated emotional state information, which leads to more efficient route computation under varying user conditions. Because emotional state influences which cost components are emphasized, server avoids computing and presenting routes that the user is unlikely to accept, thereby reducing the number of recomputations and network transactions.

Terminal and server jointly reduce cognitive overload and distraction by adapting guidance message length, tone, and frequency to the user's state. This adaptation is realized through parameterized text generation and parameter-controlled text-to-speech configurations, which are managed by machine-readable policies rather than static templates.

Server and terminal implement multi-modal emotion integration by combining acoustic features and text-based probabilities into a unified representation. This multi-modal approach yields higher accuracy in emotion estimation than either modality alone, which in turn improves the relevance of routing and safety decisions and reduces the need for user correction.

Server uses history data and generative summarization to automatically tune prompt sentences and system parameters per user. This reduces manual engineering effort and allows the system to adapt over time to changing driver behavior, without requiring retraining of all models or rewriting of application code.

By providing these concrete data flows, feature computations, prompt sentence designs, and control interactions between modules, the embodiments demonstrate that the invention is directed to specific improvements to computer-implemented navigation and driving-assistance technology, rather than to an abstract idea.

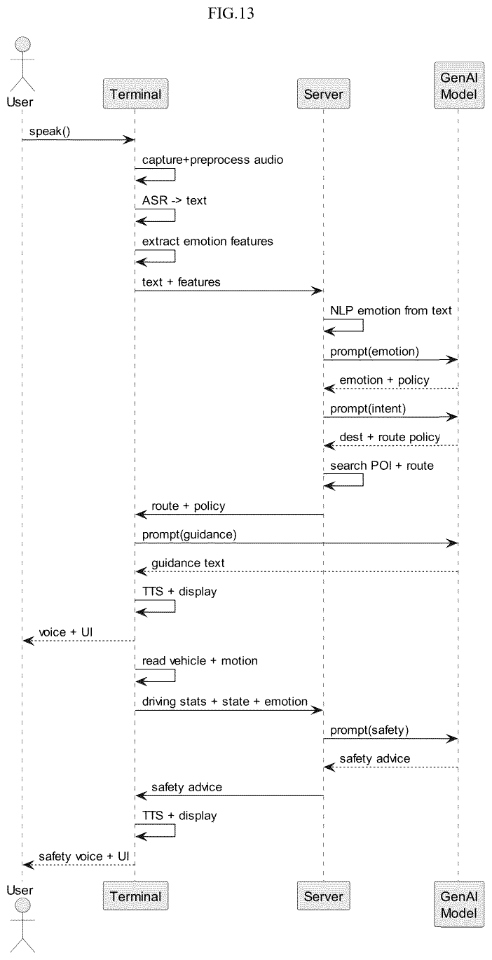

The following describes the processing flow using FIG. 13.

### Step 1:

User provides a spoken request in the vehicle cabin.
User speaks toward the terminal's microphone and articulates a navigation request, for example, “I want to get to the nearest shopping mall as quickly as possible, but I want to avoid traffic jams.”
Input: A continuous analog acoustic signal corresponding to the user's speech.
Output: An analog voltage waveform at the microphone output, representing the user's utterance, supplied to the terminal's audio input circuit.

### Step 2:

Terminal converts the analog acoustic signal into digital audio data and performs front-end processing.
Terminal samples the analog waveform using an audio codec, producing PCM samples (for example, 16 kHz, 16-bit) and stores them in memory as a digital audio buffer. Terminal applies a digital signal processing library to the buffer to perform noise suppression, echo cancellation, and voice activity detection.
Input: Analog voltage waveform from the microphone.
Data processing: Terminal executes sampling and quantization to obtain time-discrete PCM values, applies windowing and spectral estimation to estimate noise profiles, subtracts estimated noise components from the spectrum to reduce background noise, and uses energy thresholds to detect and segment voiced regions.
Output: A preprocessed digital audio stream that contains primarily the user's speech segments and is suitable for later feature extraction.

### Step 3:

Terminal extracts speech-recognition features from the preprocessed audio.
Terminal segments the preprocessed audio into overlapping frames (for example, 25 ms with 10 ms shift), applies a window function to each frame, computes a short-time Fourier transform, applies mel filter banks, computes log-mel spectra, and derives mel-frequency cepstral coefficients (MFCCs) via discrete cosine transform.
Input: Preprocessed digital audio stream.
Data processing: Terminal converts each time-domain frame into a frequency-domain representation, maps spectral power to mel-scale bands, and compresses the spectral envelope into MFCC vectors that are robust to certain noise and channel variations.
Output: A time-ordered sequence of MFCC feature vectors that describes the spectral characteristics of the user's speech.

### Step 4:

Terminal performs automatic speech recognition to convert features to text.
Terminal feeds the MFCC feature sequence into a speech recognition engine that implements an acoustic model and a language model. Terminal computes posterior probabilities over phonetic or subword units per frame and uses a decoding algorithm (such as beam search) to find the most likely text sequence given the acoustic evidence and language probabilities.
Input: Sequence of MFCC feature vectors.
Data processing: Terminal applies the acoustic model to map features to symbol probability distributions, accumulates log-likelihoods over time, combines them with language-model probabilities, and searches a decoding lattice for the best-scoring path.
Output: Text data representing the recognized utterance, for example, a character string “I want to get to the nearest shopping mall as quickly as possible, but I want to avoid traffic jams.”

### Step 5:

Terminal extracts emotion recognition features from the preprocessed audio.
Terminal uses an audio feature extraction library to compute prosodic and spectral descriptors such as fundamental frequency, energy, spectral centroid, speech rate indicators, and silence durations. Terminal aggregates these frame-level descriptors into statistical measures over the entire utterance.
Input: Preprocessed digital audio stream.
Data processing: Terminal estimates fundamental frequency per frame using autocorrelation or cepstral methods, calculates frame energy from squared sample values, computes spectral descriptors from FFT outputs, and counts voiced and silent frames to derive speech rate and silence measures. Terminal computes overall means, variances, maxima, and minima for each descriptor.
Output: A numerical emotion recognition feature vector that summarizes the prosody and timing of the user's speech.

### Step 6:

Terminal sends recognized text and emotion recognition features to the server.
Terminal constructs a structured message containing the recognized text, the emotion recognition feature vector, timestamps, and device identifiers. Terminal serializes this message in a data-interchange format and transmits it through a secure channel to the server.
Input: Text data and emotion recognition feature vector in terminal memory.
Data processing: Terminal encapsulates the data in a structured format, encrypts the payload if needed, and performs protocol framing for network transmission.
Output: A network packet stream containing text and emotion features, delivered to the server.

### Step 7:

Server receives and parses the text and emotion recognition features.
Server accepts incoming connections at a network interface, receives the structured message, and deserializes the payload to recover the recognized text and feature vector. Server stores these in a session context associated with the current user interaction.
Input: Network packet stream containing serialized text and emotion features.
Data processing: Server reassembles packets, decrypts as required, parses the structured format to extract fields, and allocates in-memory structures to hold the data.
Output: Internal data objects representing the user's text, emotion recognition features, and session metadata.

### Step 8:

Server performs text-based emotion analysis using a natural language model.
Server tokenizes the recognized text into subword tokens and feeds them into a transformer-based encoder network. Server retrieves an utterance-level embedding and applies a classification layer to compute probabilities for emotion categories such as calm, irritated, anxious, and neutral.
Input: Recognized text string.
Data processing: Server maps text characters to token IDs, propagates token embeddings through multi-head self-attention layers and feed-forward networks, pools the representation (for example, using a special classification token), and applies a dense layer with softmax activation to produce an emotion probability vector.
Output: A text emotion analysis result comprising an emotion label and a probability distribution over predefined emotion classes.

### Step 9:

Server constructs a first prompt sentence for integrated emotion estimation and calls the generative AI model.
Server generates a textual prompt that embeds the recognized text, the emotion recognition feature values, and the text emotion scores, together with instructions and expected output format. Server, for example, composes:
“You are an emotion analysis engine for an in-vehicle system.
Based on the following information, infer the driver's current emotional state and its intensity (0.0-1.0), and output a recommended support policy for a driving assistance system.

### [Audio Features]

Average fundamental frequency: . . .
Variation of fundamental frequency: . . .
Average energy: . . .
Speech rate:
Silence duration: . . .

### [Recognized Text]

‘ . . . ’

### [Text Emotion Scores]

Calm: . . .
Irritated: . . .
Anxious:

### Output:

1) Emotion label
2) Emotion intensity (0.0-1.0)
3) Recommended support policy.”
Server sends this prompt sentence to the generative AI model endpoint.
Input: Recognized text, emotion recognition feature vector, text-based emotion probability vector.
Data processing: Server formats numeric features into human-readable strings, appends them to a template, and constructs a single coherent prompt. Server then sends the prompt to the model API.
Output: A completed prompt sentence submitted to the generative AI model, and a model-generated textual response describing the emotional state and recommended policy.

### Step 10:

Server parses the generative AI model's response to obtain integrated emotional state information and support policy.
Server receives the model output as text, searches for key phrases and numeric values, and extracts the emotion label, its intensity, and policy instructions. Server validates and normalizes the extracted values.
Input: Textual response produced by the generative AI model in response to the first prompt sentence.
Data processing: Server applies pattern matching or simple parsing rules to locate lines such as “Emotion label: irritated” or “Emotion intensity: 0.75,” converts strings to numerical values, and maps descriptive policy phrases to internal flags (for example, “time_priority=high”).
Output: Integrated emotional state information (label and intensity) and support policy flags stored in the session context.

### Step 11:

Server constructs a second prompt sentence for intent and route policy extraction and calls the generative AI model.
Server uses the recognized text and the integrated emotional state to generate another prompt instructing the model to output destination type, search conditions, and route selection policy.
Server, for example, writes:
“You are an intent analysis engine for a car navigation system.
Based on the following driver utterance and emotional state, identify:
1) Destination type,
2) Search conditions,
3) Route selection policy.

### [Driver Utterance]

‘ . . . ’

### [Emotional State]

Label: . . .
Intensity: . . .

### Output:

Destination type (for example, shopping mall)
Search conditions (for example, nearest from current position, with parking)
Route selection policy (for example, minimize travel time, avoid heavy congestion).”
Server submits this prompt to the generative AI model.
Input: Recognized text and integrated emotional state information.
Data processing: Server inserts the text and emotional state into a template, forms a coherent prompt sentence, and invokes the model's generate function with defined length and sampling parameters.
Output: A model-generated textual description of destination type, search conditions, and route policy, ready for parsing.

### Step 12:

Server parses intent-related output and generates structured navigation intent data.
Server examines the model's response, identifies lines indicating destination type and constraints, and converts them into structured fields.
Input: Textual response from the generative AI model to the second prompt sentence.
Data processing: Server parses tokens around keywords such as “Destination type:” or “Search conditions:”, trims whitespace, and maps category names (for example, “shopping mall”) to internal identifiers. Server builds a navigation intent object specifying facility category, distance preference, parking requirement, and route cost priorities.
Output: Structured navigation intent data including a destination category and route selection preferences.

### Step 13:

Server searches candidate destinations and computes an emotion-aware optimal route.
Server queries a spatial database using the destination category and search conditions, retrieves facility locations around the user's current position, and constructs a list of candidate destinations. Server then uses a routing engine to compute multiple routes for each candidate, using a cost function whose weights are adjusted according to the integrated emotional state and support policy.
Input: Navigation intent data, current vehicle location, geographic spatial data, and traffic state information.
Data processing: Server performs spatial indexing lookup to obtain nearby facilities, constructs a road network graph with link attributes, and adjusts cost weights (for example, congestion penalty and toll penalty) based on emotional intensity and time priority. Server executes a shortest-path algorithm to compute route candidates and evaluates them under the adjusted cost function to select the best route.
Output: Optimal route information including a sequence of road segments, maneuver instructions, total travel time, and estimated arrival time.

### Step 14:

Server generates navigation data and transmits it to the terminal.
Server packages the optimal route information together with support policy flags (for example, concise guidance, calm tone, emphasis on arrival time) into a structured message. Server serializes and sends the message to the terminal via the network.
Input: Optimal route information and support policy flags in server memory.
Data processing: Server encodes route geometries, maneuver points, and timing information into a data structure, attaches policy indicators, and formats the composite object for network transmission.
Output: A network message containing navigation data and control flags, delivered to the terminal.

### Step 15:

Terminal receives navigation data and selects the next maneuver.
Terminal deserializes the navigation message, recovers the optimal route and policy flags, and compares the current vehicle position with route segments to determine the upcoming maneuver (for example, “turn right at the intersection 500 meters ahead”) and corresponding estimated arrival time.
Input: Navigation data message from the server and current GPS position of the vehicle.
Data processing: Terminal maps the current position onto the route polyline, identifies the next unexecuted maneuver, and reads its distance and associated ETA from the route data.
Output: A local representation of the next maneuver, ETA, and associated policy flags for guidance generation.

### Step 16:

Terminal constructs a third prompt sentence for guidance message generation and requests output from the generative AI model.
Terminal creates a prompt that describes the upcoming maneuver, ETA, user emotional state, and guidance style constraints. Terminal, for example, generates:
“You are a conversation agent for an in-vehicle navigation system.
The driver is currently in an ‘irritated’ state and wants to arrive as quickly as possible.
Based on the following route information and policy, create one short guidance sentence with a calm tone that does not increase stress.

### [Route Information]

Next maneuver: turn right at the intersection 500 meters ahead
Estimated time of arrival: 15 minutes

### [Policy]

Briefly mention that arrival will be soon
Omit unnecessary explanations
Avoid commanding expressions.”
Terminal sends this prompt to the generative AI model via the server or a local model interface.
Input: Next maneuver data, ETA, integrated emotional state, and policy flags.
Data processing: Terminal embeds these values into a textual template and verifies that constraints such as “one sentence” are explicitly stated. Terminal then calls the model interface to request a generated response.
Output: A guidance message text produced by the generative AI model, describing the maneuver and ETA in the desired style.

### Step 17:

Terminal synthesizes and outputs voice guidance based on the guidance message text.
Terminal passes the guidance message text to a text-to-speech engine and configures synthesis parameters (speech rate, pitch, volume, and voice quality) according to the emotional state and policy. Terminal generates an audio waveform and outputs it through the loudspeaker.
Input: Guidance message text and emotional state information.
Data processing: Terminal converts text into phoneme sequences, applies an acoustic model and a vocoder to create a waveform, and scales timing and amplitude to match the configured parameters.
Output: A spoken guidance message that the user hears and can follow to perform the next driving maneuver.

### Step 18:

Terminal renders visual guidance on the display in an emotion-adaptive format.
Terminal uses a map rendering engine to draw the current position, the route path, and the next maneuver icon. Terminal adjusts visual density, font sizes, and emphasis according to the policy (for example, simpler layout and larger maneuver arrows when the user is irritated).
Input: Route geometry, maneuver data, current position, and policy flags.
Data processing: Terminal selects which UI elements to show or hide, computes screen coordinates for route and icons, and chooses color and size parameters based on the emotional state.
Output: A visual navigation interface that presents the route and upcoming maneuver in a form tailored to the user's state.

### Step 19:

Terminal acquires vehicle state information and driving behavior information.
Terminal periodically reads signals from vehicle state detection sensors (fuel level, tire pressure, power system status, braking system status) and motion sensors (accelerometer, gyroscope).
Terminal detects sudden operation events by comparing measured accelerations and angular velocities against thresholds.
Input: Raw sensor readings from the vehicle bus and motion sensors.
Data processing: Terminal converts sensor-specific units into normalized values, maintains counters for events exceeding thresholds, and aggregates data over predefined time windows.
Output: Vehicle state information and driving behavior information summarizing current operating conditions, including counts of hard accelerations and hard brakings.

### Step 20:

Server or terminal evaluates a safe driving risk and constructs a fourth prompt sentence for a safe driving advice message.
Server or terminal combines the aggregated driving behavior information, vehicle state information, and integrated emotional state information into a risk profile. Server or terminal computes a risk score by weighting event counts and emotional intensity. Based on this profile, server or terminal composes a prompt such as:
“You are a safe-driving advisor for an in-vehicle system.
Using the following information, create one short message that encourages safer driving while taking the driver's feelings into account.

### [Emotional State]

Label: irritated
Intensity: 0.8

### [Driving Behavior]

Hard accelerations in the last 10 minutes: 5
Hard brakings in the last 10 minutes: 4

### [Vehicle State]

Fuel remaining: 20%
Distance to next fuel station: 15 km

### Conditions:

Do not blame or scold the driver.
Include at least one reassuring phrase.”
Input: Vehicle state information, driving behavior information, and integrated emotional state information.
Data processing: Server or terminal normalizes sensor-derived metrics, calculates a combined risk index, and embeds key values and conditions into a textual template to form the prompt sentence.
Output: A completed prompt sentence describing safe driving context, and a model-generated safe driving advice message.

### Step 21:

Terminal outputs the safe driving advice and updates history data.
Terminal receives the safe driving advice text from the server or from a local model, synthesizes speech in a gentle tone, and displays the advice on the screen. Server records in a database the emotional state, route taken, advice given, and any detected changes in driving behavior after the advice.
Input: Safe driving advice text, and current context information (emotion, vehicle state, driving behavior).
Data processing: Terminal performs text-to-speech synthesis and display rendering; server associates the advice event with sensor data and stores a new history record.
Output: An audible and visual safe driving message for the user, and updated history data enabling subsequent personalization and refinement of prompt sentences and system parameters.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional in-vehicle navigation systems generally convert user speech into text, extract a destination through rule-based or statistical natural language processing, and compute a route based mainly on objective metrics such as distance, travel time, and congestion. While these systems can provide basic guidance, they exhibit several technical limitations when implemented on modern computer architectures.

First, existing systems do not integrate the acoustic characteristics of the user's speech and the linguistic content of the utterance into a unified, machine-interpretable representation of the user's emotional state. As a result, the navigation logic cannot adapt its route selection or guidance style to real-time psychological conditions such as stress or anxiety. At the system level, this leads to a rigid control flow in which the navigation processor uses fixed weights and fixed cost functions for route evaluation, independent of user state, thereby limiting the effectiveness and responsiveness of the navigation computation.

Second, conventional systems that employ natural language generation or dialogue techniques typically use static templates or simple rule-based text generation. Even when a generative AI model is used, the model is often invoked in an ad hoc manner: the prompts given to the generative AI model do not systematically encode structured navigation data (route attributes, traffic metrics) and emotion state vectors, and the outputs of the model are not fed back into the navigation and emotion-estimation components in a closed loop. This results in suboptimal utilization of compute resources, fragmented data flows, and difficulty in maintaining consistency between the route computation pipeline and the explanation generation pipeline.

Third, conventional navigation architectures generally treat traffic data integration, route evaluation, and guidance as loosely coupled modules. They compute scalar cost values from traffic databases, but they do not separate and recombine multiple evaluation layers-such as a first layer for time/distance and a second layer for psychological load- and they do not dynamically re-parameterize these layers based on a learned emotion state vector. Consequently, the processor cannot exploit the full advantages of modern machine learning, such as multimodal emotion estimation and adaptive weighting, to optimize the internal route evaluation algorithm for both objective and subjective criteria.

Fourth, existing systems often lack a systematic logging and learning mechanism that captures, in a structured manner, the prompts sent to the generative AI model, the responses from that model, the computed emotion state vectors, the route evaluation results, and subsequent user operations such as route changes. Without such integrated logs, it is difficult for the system to retrain its models and to refine its prompt sentence templates. This hampers continuous improvement of the underlying computer models and limits the long-term adaptability and performance of the navigation platform.

Accordingly, there is a need for a computer-implemented navigation system that: (i) generates and uses an emotion state vector from both text data and acoustic features to drive downstream routing computations; (ii) systematically constructs and uses prompt sentences for a generative AI model to refine destination information and to generate explanation or proposal texts; (iii) combines multi-layer route evaluation values, including psychological load indices, in a manner that is dynamically modulated by the emotion state vector; and (iv) logs all relevant intermediate and final data to enable iterative learning and prompt optimization. Such a system should improve the functioning of the underlying computer components by optimizing memory structures, data flows, and processing pipelines for emotion-aware route computation and generative explanation, rather than merely automating human navigation tasks.

The specific processing by the specific processing unit 290 of the data processing device 12 in Application Example 2 is realized by the following means.

The present invention provides a server comprising a processor and a memory storing instructions that, when executed by the processor, cause the processor to acquire voice data of a user through an input device, perform noise reduction processing and utterance section extraction processing on the voice data to calculate speech recognition features and acoustic features for emotion estimation, convert the voice data into text data based on the speech recognition features, perform natural language processing on the text data to identify an intention of the user and destination-related information and to extract a candidate location, calculate an emotion state vector including at least a stress index and an anxiety index based on the text data and the acoustic features for emotion estimation, generate a first prompt sentence including the text data and current position information of the user, input the first prompt sentence to a generative AI model, obtain a text response relating to an official name and position information of the candidate location from the generative AI model, and specify coordinates of the candidate location based on geographic information data, generate a plurality of route candidates based on the current position information and the coordinates of the candidate location, calculate, for each of the route candidates, a first evaluation value based on evaluation indices including at least required time, distance, and congestion degree derived from traffic information acquired from an external information source, calculate a second evaluation value based on psychological load evaluation indices including at least a number of right turns, a number of merge points, a complexity of intersections, and a scenery evaluation, calculate an overall evaluation value for each of the route candidates according to at least the emotion state vector and the first and second evaluation values, and select a recommended route based on the overall evaluation values, generate a second prompt sentence to be input to the generative AI model by using the emotion state vector and information relating to the route candidates including the recommended route, input the second prompt sentence to the generative AI model to cause the generative AI model to generate, as a response to the second prompt sentence, an explanation text relating to the recommended route or a proposal text relating to the route candidates, and output route guidance to the user through a display device and a voice output device based on the recommended route and the explanation text or the proposal text, and further cause the processor to record, in an associated storage device, at least the first and second prompt sentences, text responses output from the generative AI model, the emotion state vector, evaluation results relating to the recommended route and the route candidates, and history information relating to a route change operation or a destination change operation performed by the user, and to learn or update an emotion estimation model and a route evaluation model and improve a template of the prompt sentence to be input to the generative AI model based on the recorded information. This enables the server to implement an integrated, machine-optimized processing pipeline in which multimodal emotion estimation, route evaluation, and generative explanation are tightly coupled, whereby the internal cost functions and prompt sentences are adaptively refined over time, improving computational efficiency, response quality, and robustness of the navigation system when executed on general-purpose computing hardware.

The term “voice data” refers to digital data representing a time-varying acoustic signal obtained by sampling an analog sound pressure signal produced by a user.

The term “input device” refers to a hardware component configured to receive user input, including at least a sound acquisition device that converts a user's speech into an electrical signal.

The term “noise reduction processing” refers to signal processing that estimates and suppresses or removes unwanted background components from voice data, including at least vehicle noise, environmental noise, and silence segments.

The term “utterance section extraction processing” refers to processing that detects and extracts time intervals within voice data that contain speech segments, while excluding non-speech intervals such as silence or pure noise, based on acoustic criteria.

The term “speech recognition features” refers to numerical feature vectors calculated from voice data and used as input to a speech recognition model, including at least time-series spectral or cepstral parameters.

The term “acoustic features for emotion estimation” refers to numerical parameters derived from voice data that characterize prosodic and spectral properties related to a user's emotional state, including at least pitch, energy, speaking rate, and spectral distribution.

The term “text data” refers to digital data that represents linguistic content of a user's utterance as a sequence of characters or tokens in a natural language.

The term “natural language processing” refers to computational processing applied to text data to analyze linguistic structure and meaning, including at least tokenization, syntactic analysis, semantic analysis, and intention classification.

The term “intention of the user” refers to information indicating a purpose or request contained in a user's utterance, including at least a request to set or change a destination, a request to change a route, or a request to specify a preference relating to route selection.

The term “destination-related information” refers to information contained in text data that indicates at least one target location, facility type, geographical area, or preference used to determine a navigation destination.

The term “candidate location” refers to a possible destination point inferred from destination-related information and represented by at least one of a facility identifier, a place name, an address, or coordinates.

The term “emotion state vector” refers to a numerical vector including a plurality of elements that quantify degrees of different emotional dimensions of a user, including at least a stress index and an anxiety index, and optionally further including a boredom index and a satisfaction index.

The term “stress index” refers to a numerical value within a predetermined range representing an estimated degree of psychological stress experienced by a user, calculated from at least acoustic features for emotion estimation and text data.

The term “anxiety index” refers to a numerical value within a predetermined range representing an estimated degree of psychological anxiety experienced by a user, calculated from at least acoustic features for emotion estimation and text data.

The term “boredom index” refers to a numerical value within a predetermined range representing an estimated degree of psychological boredom experienced by a user, calculated from at least acoustic features for emotion estimation and text data.

The term “satisfaction index” refers to a numerical value within a predetermined range representing an estimated degree of psychological satisfaction experienced by a user, calculated from at least acoustic features for emotion estimation and text data.

The term “prompt sentence” refers to text data that includes instructions, conditions, and contextual information and is input to a generative AI model to cause the generative AI model to generate an output according to a desired behavior.

The term “generative AI model” refers to a trained artificial intelligence model configured to generate text data or other data in response to an input prompt sentence based on parameters obtained through machine learning on large-scale training data.

The term “text response” refers to text data output from a generative AI model as a result of processing a prompt sentence, the text data including at least information requested by the prompt sentence.

The term “position information” refers to data indicating a geographical position, including at least coordinate values such as latitude and longitude.

The term “coordinates of the candidate location” refers to position information specifying a location on a geographical reference system associated with a candidate location, including at least latitude and longitude values.

The term “geographic information data” refers to data representing geographical entities, including at least map data, address data, and coordinate data used to associate place identifiers with coordinates.

The term “current position information” refers to position information indicating a current geographical location of a device or vehicle at a particular time.

The term “route candidate” refers to data representing a path between a starting position and a destination, including at least an ordered sequence of segments of a transportation network and attributes of the segments.

The term “traffic information” refers to data indicating a state of a transportation network, including at least congestion, travel speed, road restrictions, and incidents that affect travel.

The term “evaluation index” refers to a scalar or vector quantity used to quantitatively evaluate a route candidate, including at least required time, distance, congestion degree, or psychological load.

The term “required time” refers to an estimated travel duration along a route candidate calculated from segment lengths, permissible speeds, and traffic information.

The term “congestion degree” refers to an index indicating a density or slowness of traffic along a route or segment based on traffic information.

The term “psychological load evaluation index” refers to a numerical quantity that estimates a degree of psychological burden a user may experience when traveling along a route candidate, including at least a number of right turns, a number of merge points, a complexity of intersections, and a scenery evaluation.

The term “number of right turns” refers to a count of turning maneuvers in a predetermined direction, defined relative to a direction of travel, that are included in a route candidate.

The term “number of merge points” refers to a count of locations along a route candidate where at least two traffic flows merge and a driver or vehicle must adapt to joining traffic.

The term “complexity of intersections” refers to a metric indicating a structural or operational complexity of intersections included in a route candidate, including at least a number of intersecting roads, number of traffic signal phases, and lane configuration.

The term “scenery evaluation” refers to an index indicating a relative quality of surroundings along a route candidate, including at least whether the route passes through visually preferred areas such as green zones, waterfronts, or open landscapes.

The term “first evaluation value” refers to a value calculated for a route candidate based on objective indices including at least required time, distance, and congestion degree.

The term “second evaluation value” refers to a value calculated for a route candidate based on psychological load evaluation indices including at least a number of right turns, a number of merge points, a complexity of intersections, and a scenery evaluation.

The term “overall evaluation value” refers to a value computed for a route candidate by combining at least the first evaluation value, the second evaluation value, and the emotion state vector according to a predetermined or learned combination rule.

The term “recommended route” refers to a route candidate selected as preferred among a plurality of route candidates based on comparison of the overall evaluation values.

The term “explanation text” refers to text data describing features and advantages of the recommended route, including at least information about travel time, psychological load, and route characteristics, generated for presentation to a user.

The term “proposal text” refers to text data describing a comparison or set of options among a plurality of route candidates, generated for presentation to a user to support route selection.

The term “route guidance” refers to information output to a user through at least a display device and a voice output device that indicates navigation instructions for traveling along a route, including at least maneuvers, distances, and directions.

The term “display device” refers to an output device configured to visually present information, including at least graphical indications of maps, routes, and textual guidance.

The term “voice output device” refers to an output device configured to convert audio data into sound, including at least a loudspeaker for presenting spoken guidance to a user.

The term “external information source” refers to a system or service external to the system that provides traffic information or other environmental information via a communication network.

The term “evaluation result” refers to information indicating values of the first evaluation value, the second evaluation value, the overall evaluation value, or intermediate metrics for a route candidate.

The term “route change operation” refers to an operation performed by a user or controlling entity to request a change from a current recommended route to another route.

The term “destination change operation” refers to an operation performed by a user or controlling entity to request a change of a navigation destination or to add or remove a destination.

The term “emotion estimation model” refers to a computational model configured to estimate an emotion state vector from at least acoustic features for emotion estimation and text data.

The term “route evaluation model” refers to a computational model configured to calculate at least the first evaluation value, the second evaluation value, or the overall evaluation value for route candidates based on route attributes, traffic information, and an emotion state vector.

The term “prompt sentence template” refers to a predefined structure or pattern for constructing a prompt sentence, including placeholders for text data, route attributes, and emotion information, which is used to systematically generate prompt sentences for a generative AI model.

In one embodiment, a system includes a server, at least one in-vehicle terminal, and one or more external information sources interconnected via a communication network. The server, the terminal, and the external information sources each include at least one processor, a memory, a communication interface, and one or more storage devices. The server and the terminal execute software components that implement the functions defined in the claims.

The terminal is mounted in a vehicle and functions as an in-vehicle information apparatus. The terminal includes a microphone as an input device, a loudspeaker as a voice output device, and a display panel as a display device. The terminal further includes an embedded operating system such as an embedded Linux-based OS or an automotive operating system, an audio subsystem such as ALSA and PulseAudio, or an audio service of a mobile operating system, and a graphics subsystem such as an OpenGL-based renderer or a map SDK.

The terminal uses the microphone and the audio subsystem to acquire analog speech of a user and to generate corresponding digital voice data. The terminal configures the audio driver to sample the incoming analog audio at a sampling rate (for example, 16 kHz) and a bit depth (for example, 16-bit linear PCM), and stores successive frames of raw PCM samples in a circular buffer in the memory. The terminal provides the raw PCM data to a digital signal processing library, such as a fast Fourier transform library or an acoustic analysis library, to perform noise reduction processing and utterance section extraction processing. The terminal performs a short-time Fourier transform, estimates a background noise spectrum from low-energy segments, subtracts the estimated noise spectrum from the observed spectrum, applies spectral flooring, and reconstructs a time-domain signal using inverse transforms. The terminal then applies a voice activity detection algorithm based on frame energy and zero-crossing rate to identify and extract frames corresponding to speech segments, thereby generating de-noised and trimmed voice data.

The terminal converts the voice data into speech recognition features for input to an automatic speech recognition (ASR) engine. The terminal segments the voice data into overlapping frames, applies a window function, computes magnitude spectra using the fast Fourier transform, and applies a Mel filter bank to obtain Mel band energies. The terminal applies a logarithmic function to the Mel band energies and computes Mel-frequency cepstral coefficients (MFCCs) by applying a discrete cosine transform. The terminal generates a time-series of MFCC feature vectors, optionally including first-order and second-order differences, and stores the feature vectors in a feature buffer as a two-dimensional array (time index and feature dimension).

The terminal executes the ASR engine, which is implemented as a neural network-based acoustic model coupled with a language model. In one embodiment, the acoustic model is a deep neural network with multiple fully connected layers or convolutional layers followed by one or more recurrent layers or transformer layers. The terminal feeds each frame of MFCCs into the acoustic model, which computes posterior probabilities over phoneme units or subword units at each time step. The terminal executes a decoder that performs beam search over sequences of units using the output of the acoustic model and probabilities from a language model, such as an n-gram model or a transformer-based model. The terminal selects the most probable sequence according to a likelihood function and outputs text data representing the user's utterance, together with a recognition confidence score.

The terminal also calculates acoustic features for emotion estimation from the same de-noised voice data. The terminal applies a pitch extraction algorithm, such as an autocorrelation-based method or a YIN-type method, to estimate a fundamental frequency contour. The terminal calculates frame-level energy, speaking rate (for instance, by dividing the duration of speech segments by an estimate of syllable or phoneme count), and spectral centroid. The terminal aggregates these acoustic features into numerical vectors and associates them with the corresponding text data. The terminal creates a structured message including at least the text data, the acoustic features for emotion estimation, a user identifier, a timestamp, and current position information obtained from a positioning subsystem such as a GNSS receiver. The terminal serializes the structured message as a JSON-like structure in memory and sends it to the server over a network using an encrypted transport protocol such as TLS over HTTP.

The server receives the structured message via its communication interface and a web server framework. The server deserializes the message, validates the fields, and stores the text data, the acoustic features for emotion estimation, the current position information, and the metadata in memory. The server performs natural language processing on the text data. In one embodiment, the server uses a morphological analyzer to segment the text into tokens and to assign part-of-speech tags. The server then applies a named entity recognition model implemented as a neural sequence labeling network, for example, a transformer-based model, to identify entities such as facility types and place names. The server further applies an intent classification model implemented as a neural classifier that receives token embeddings as input and outputs an intent label, such as destination setting, route change, or preference specification. The server extracts destination-related information from the text data based on the identified entities and the intent label, and outputs at least one candidate location expressed as a semantic descriptor (for example, “art museum in the city”).

The server computes an emotion state vector from the acoustic features for emotion estimation and the text data. In one embodiment, the server uses a multimodal emotion estimation model implemented as a neural network composed of two sub-networks and a fusion network. The server feeds the acoustic features for emotion estimation into an acoustic sub-network that includes fully connected layers and non-linear activation functions to produce an acoustic embedding. The server tokenizes the text data and maps tokens to embeddings using a learned embedding matrix, and feeds the sequence of embeddings into a text sub-network, which may be a recurrent network, a convolutional network, or a transformer encoder, to produce a text embedding. The server concatenates the acoustic embedding and the text embedding to form a combined feature vector and then feeds the combined feature vector into a fusion network that outputs an emotion state vector. The emotion state vector at least includes a stress index and an anxiety index, and may also include a boredom index and a satisfaction index. The server can train this multimodal model in advance by supervised learning using training data containing labeled emotional states. During training, the server defines an error function such as mean squared error between predicted indices and ground truth labels, and updates network weights by gradient descent or a variant such as Adam optimization, using backpropagation through all layers.

The server uses a generative AI model in conjunction with prompt sentences. The generative AI model is implemented as a large language model trained on text corpora, for instance, by using transformer layers with self-attention and feed-forward networks. In one embodiment, the server invokes an external generative AI service via an API. In another embodiment, the server executes a local generative AI model. The server constructs a prompt sentence that includes the text data and the current position information to refine the candidate location. For example, the server constructs the following prompt sentence:
“Given the user utterance text ‘I wish to visit an art museum in the city.’ and the assumption that the current position is in the center of the city, select the single most typical art museum candidate and output its name and address in Japanese.”

The server sends the prompt sentence to the generative AI model, receives a text response containing at least a facility name and an address, and parses the text to extract structured information. The server uses the facility name and address as keys to query geographic information data, such as a map database or a geocoding service, and obtains coordinates of the candidate location in terms of latitude and longitude. The server uses these coordinates as the destination for route planning.

The server generates a plurality of route candidates between the current position and the coordinates of the candidate location by using a route search engine. In one embodiment, the server represents a road network as a directed graph stored in a database, where nodes represent intersections and edges represent road segments. The server executes a pathfinding algorithm such as Dijkstra's algorithm or an A* search algorithm with heuristic functions to compute different types of route candidates, such as a fastest route, a shortest route, and a route with fewer complex maneuvers. The server requests traffic information from an external information source, such as a traffic information server, via a communication interface. The server maps the received traffic information, including congestion levels and incidents, onto the links of the road network by matching segment identifiers, and updates travel time attributes of the links.

The server calculates, for each route candidate, a first evaluation value representing objective attributes such as required time, distance, and congestion degree. The server sums per-link travel times and per-link distances along the route and computes a congestion degree by aggregating congestion levels across links. The server then calculates a second evaluation value representing psychological load by counting the number of right turns, the number of merge points, and the number of complex intersections and by aggregating scenery evaluations for links along the route. The server may precompute a scenery evaluation for each link based on map attributes such as proximity to water bodies, parks, or other visually preferred areas.

The server combines the first and second evaluation values with the emotion state vector to compute an overall evaluation value for each route candidate. In one embodiment, the server defines weight parameters for each component of the second evaluation value and modifies the weights dynamically according to the stress index and the anxiety index. For instance, when the stress index and the anxiety index exceed predetermined thresholds, the server increases the weights associated with the number of right turns and the number of merge points, which causes routes with many such maneuvers to receive higher penalties in the overall evaluation value. The server may use a linear combination or a more complex function, such as a learned neural network, to combine these values. Because the weights are adjusted as a function of the emotion state vector, the server automatically adapts its internal routing cost function to the current psychological state of the user without manual rule changes. This structure yields technical effects such as reduced computation of obviously unsuitable routes in high-stress conditions and improved efficiency in route selection.

The server selects a recommended route as the route candidate having the best overall evaluation value based on a comparison operation implemented in software. The server may also select one or more alternative routes. The server then constructs a second prompt sentence for the generative AI model by embedding route attributes and the emotion state vector into natural language. For example, the server constructs a prompt sentence such as:
“You are the navigation system of an autonomous vehicle. The user's emotional state shows high stress and moderately high anxiety, while boredom is low. Route A requires 20 minutes, includes 2 right turns and 1 merge, and passes along a scenic riverside road. Route B requires 15 minutes, includes 5 right turns and 3 merges, and has average scenery. Prioritizing reduction of psychological load, create a 2-3 sentence Japanese explanation that recommends Route A.”

The server sends the second prompt sentence to the generative AI model and receives an explanation text or a proposal text. The server may perform post-processing, such as enforcing polite language or filtering prohibited terms. The server sends the recommended route, the alternative routes, the explanation text or proposal text, and the emotion state vector to the terminal.

The terminal receives the route and guidance data, parses the received data, and displays the recommended route on the display device. The terminal uses a map rendering engine or SDK to transform geographic coordinates into screen coordinates and draws polylines representing the routes. The terminal displays the recommended route in one color and the alternative routes in another color, and shows additional textual information such as estimated arrival time. The terminal uses a text-to-speech engine to synthesize speech from the explanation text. The terminal sets prosodic parameters of the TTS engine, such as pitch and speaking rate, based on the emotion state vector. For example, when the stress index and the anxiety index are high, the terminal reduces the pitch and slightly lowers the speaking rate to generate a calmer voice. The terminal outputs synthesized speech through the voice output device and updates the display as the vehicle moves along the recommended route.

The user observes the visual guidance and listens to the spoken guidance, and may operate the terminal through a touch panel to request a route change or a destination change. The terminal interprets the user operation, packages the operation details into a structured message, and sends the message to the server. The server receives the operation, recalculates route candidates or updates the destination, and repeats the evaluation and generative explanation process described above, thereby providing updated guidance.

The server records, in a storage device, log data including at least the first and second prompt sentences, the text responses from the generative AI model, the emotion state vectors, evaluation results for the route candidates, and history information relating to route change operations and destination change operations. The server periodically executes training jobs for the emotion estimation model and the route evaluation model using the log data. During these jobs, the server organizes the stored data into training batches, computes error values between predicted outputs and inferred or labeled targets, and updates model parameters via gradient-based optimization.

The server may also modify the prompt sentence templates based on analysis of the relationship between prompts and model outputs, for example by adjusting phrasing to reduce ambiguity.

This closed-loop learning architecture improves model accuracy over time and reduces the need for manual rule tuning, thus providing technical effects such as increased prediction precision and decreased response latency.

The described architecture improves computer technology by introducing specific data structures and processing flows that are not mere automation of human navigation tasks. The system stores emotion state vectors, evaluation indices, and route structures in defined memory formats and uses these data structures in combination with neural models and heuristic algorithms to compute adaptive cost functions for routing. The dynamic weighting of psychological load indices reduces the computational search space for candidate routes in stressful conditions by penalizing certain structural patterns (such as frequent merges) in the graph, thereby enabling faster convergence to a suitable recommended route. The integration of prompt sentences with structured route and emotion data allows the generative AI model to operate on a compact, information-rich input, which reduces the need for extensive back-and-forth communication and lowers network bandwidth usage. The logging and retraining mechanism improves data management by maintaining consistent, structured records of prompts, responses, evaluations, and operations, which can be directly used to re-optimize models and prompt templates without manual reformatting.

The neural network architectures, error functions, and training procedures are concretely specified, and the server executes defined algorithms such as fast Fourier transforms, Mel filter banks, Dijkstra or A* searches, and gradient descent. The system does not simply replace human commentary with machine commentary; instead, the server adjusts internal model parameters and routing weights in ways that humans cannot easily replicate at scale or in real time. As a result, the system achieves improvements in prediction accuracy for emotion states, in quality and relevance of route explanations, and in computational efficiency of route search, thereby enhancing the functioning of the computing hardware and yielding technical benefits in real-world navigation and in-vehicle device control. Multiple embodiments are possible, including variations in model architectures, feature sets, and prompt sentence templates, while the essential structure of integrating emotion-aware route evaluation with generative AI-based explanation through defined data flows remains consistent.

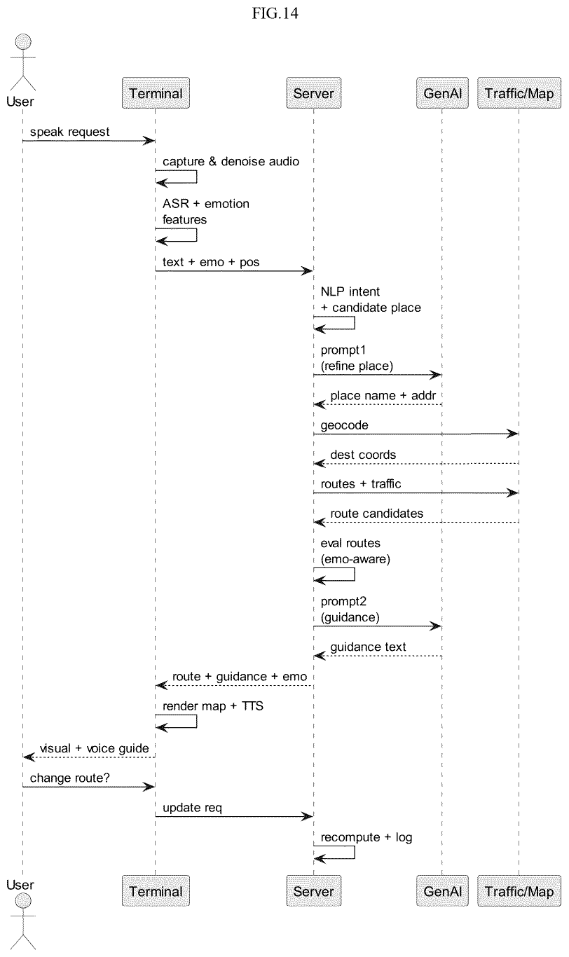

The following describes the processing flow using FIG. 14.

### Step 1:

User speaks a navigation request toward the terminal.
User, for example, says “I want to go to the art museum in the city” or “Please guide me along a scenic route.”
Input: No digital input; the user produces an analog acoustic signal in air.
Output: An analog sound pressure wave that propagates to the in-vehicle microphone.

### Step 2:

Terminal acquires the analog voice signal from the microphone and generates raw digital voice data.
Terminal configures the audio driver of the embedded operating system (for example, an ALSA-based or mobile OS audio subsystem) to sample at 16 kHz, 16-bit linear PCM. Terminal continuously reads from the microphone input, converts the analog signal via an A/D converter, and stores frames of PCM samples into a recording buffer in memory.
Input: Analog electrical signal from the microphone.
Data processing: Terminal performs sampling and quantization (A/D conversion) at fixed time intervals and arranges the resulting integers into a time-ordered array.
Output: Raw PCM voice data containing speech and background noise.

### Step 3:

Terminal performs noise reduction and utterance section extraction on the raw PCM voice data.
Terminal divides the raw PCM data into overlapping frames (for example, 25 ms with 10 ms shift) and applies a window function. Terminal calls a fast Fourier transform routine (for example, from a DSP or FFT library) to compute a spectrum for each frame. Terminal estimates a noise spectrum by averaging low-energy frames and subtracts this estimated noise spectrum from each speech frame, applying spectral flooring. Terminal then performs inverse FFT to reconstruct time-domain samples and applies a voice activity detection algorithm based on frame energy and zero-crossing rate to mark and retain only speech segments, concatenating them into a trimmed waveform.
Input: Raw PCM voice data.
Data processing: Terminal performs STFT, noise spectrum estimation, spectral subtraction, inverse STFT, and VAD-based frame selection to enhance speech and remove silence.
Output: De-noised and trimmed PCM voice data representing speech segments only.

### Step 4:

Terminal extracts speech recognition features from the de-noised voice data.
Terminal again segments the de-noised waveform into overlapping frames, applies a window function, and computes magnitude spectra using FFT. Terminal passes the spectra through a Mel filter bank, computes log Mel band energies, and then applies a discrete cosine transform to obtain Mel-frequency cepstral coefficients (MFCCs). Terminal optionally adds delta and delta-delta coefficients and stores the vectors in a feature buffer.
Input: De-noised and trimmed PCM voice data.
Data processing: Terminal executes FFT, Mel filter bank application, logarithm, and DCT to transform time-domain samples into compact spectral-cepstral feature vectors.
Output: Time-series MFCC feature vectors for speech recognition.

### Step 5:

Terminal runs the automatic speech recognition engine to convert features into text.
Terminal feeds the MFCC vectors into a neural acoustic model (for example, a deep network with fully connected, convolutional, or recurrent layers) and computes posterior probabilities over phonemes or subword units per frame. Terminal executes a decoder that combines acoustic posteriors with a language model (e.g., n-gram or transformer-based) using beam search to find the most likely sequence of tokens. Terminal converts the token sequence into a human-readable text string and associates a confidence score.
Input: MFCC feature vectors.
Data processing: Terminal performs neural network forward passes, probability computations, and beam search decoding to infer the best text hypothesis.
Output: Text data representing the user's utterance and a recognition confidence score.

### Step 6:

Terminal extracts acoustic features for emotion estimation from the de-noised voice data.
Terminal applies a pitch extraction algorithm (for example, autocorrelation-based or YIN) to estimate the fundamental frequency (FO) per frame. Terminal computes frame-level energy, detects voiced segments, and calculates speaking rate as the ratio of voiced frames to overall utterance duration or by counting estimated phones. Terminal calculates spectral centroid and other timbre-related measures. Terminal aggregates these statistics over the utterance (e.g., means, variances) into an acoustic feature vector.
Input: De-noised and trimmed PCM voice data.
Data processing: Terminal applies pitch tracking, energy computation, voiced/unvoiced detection, and spectral analysis to derive prosodic and spectral descriptors.
Output: Acoustic feature vector for emotion estimation.

### Step 7:

Terminal packages recognition and emotion data and sends it to the server.
Terminal constructs a structured message including the text data, the recognition confidence score, the acoustic feature vector, a user identifier, a timestamp, the current position (latitude and longitude from a GNSS subsystem), and a language code. Terminal serializes this structure into a JSON string, opens an HTTPS connection using TLS, and places the JSON in the body of a POST request addressed to the server's API endpoint.
Input: Text data, confidence score, acoustic feature vector, user ID, timestamp, and current position.
Data processing: Terminal encodes the data into a JSON structure, performs serialization, and encrypts the communication channel with TLS.
Output: Encrypted network message containing structured recognition and context data sent to the server.

### Step 8:

Server receives, decrypts, and parses the message from the terminal.
Server accepts the HTTPS request via a web server component, terminates TLS, and retrieves the JSON payload. Server parses the JSON, performs schema validation, and maps fields to internal data structures in memory. Server stores the text data, acoustic feature vector, position information, and metadata in a processing context.
Input: Encrypted network message with JSON payload.
Data processing: Server performs decryption, JSON parsing, type checking, and assignment to internal variables or objects.
Output: Internal representation of the utterance text, acoustic features, current position, user ID, and associated metadata.

### Step 9:

Server performs natural language processing to extract intent and destination clues.
Server uses a tokenization and morphological analysis tool to segment the text into tokens and annotate part-of-speech tags. Server feeds the token sequence into an intent classification model (for example, a transformer-based classifier) that outputs an intent label such as “destination setting” or “route preference.” Server applies a named entity recognition model to identify place names, facility types, and other destination-related expressions. Server aggregates these outputs to form destination-related information and at least one candidate location descriptor (e.g., “art museum in the current city”).
Input: Text data representing the user's utterance.
Data processing: Server performs tokenization, POS tagging, intent classification, and named entity recognition using neural models and rule logic to extract semantic structure.
Output: Intent label and candidate location descriptor(s) derived from the text.

### Step 10:

Server estimates the user's emotion state vector from acoustic and textual data.
Server normalizes the acoustic feature vector (for example, by subtracting a mean and dividing by a standard deviation) and converts it into a tensor. Server tokenizes the text and generates token embeddings using an embedding matrix. Server feeds the acoustic tensor into an acoustic sub-network (e.g., MLP or CNN) to produce an acoustic embedding and feeds the token embeddings into a text sub-network (e.g., RNN or transformer encoder) to produce a text embedding. Server concatenates the embeddings and processes them with a fusion network that outputs continuous values for emotional dimensions, including at least stress index and anxiety index.
Input: Acoustic feature vector and text data.
Data processing: Server performs feature normalization, embedding generation, and a sequence of neural network forward passes in acoustic, text, and fusion networks to regress emotion indices.
Output: Emotion state vector including at least stress index and anxiety index (and optionally boredom and satisfaction indices).

### Step 11:

Server constructs a first prompt sentence for the generative AI model to refine the candidate location.
Server embeds the text data and the current position context into a natural-language instruction.
Server, for example, constructs the following prompt sentence:
“Given the user utterance text ‘I wish to visit an art museum in the city.’ and the assumption that the current position is in the center of the city, select the single most typical art museum candidate and output its name and address in Japanese.”
Input: Candidate location descriptor and current position information.
Data processing: Server formats the descriptor and position context into a grammatically coherent instruction string according to a pre-defined template.
Output: First prompt sentence to be sent to the generative AI model.

### Step 12:

Server sends the first prompt sentence to the generative AI model and parses the response.
Server transmits the prompt sentence to a generative AI service (for example, a large language model endpoint) via HTTPS, specifying generation parameters such as maximum length and temperature. Server receives a text response that contains at least a facility name and an address.
Server applies string processing and pattern matching rules (e.g., regular expressions) to extract the facility name and the address from the response.
Input: First prompt sentence.
Data processing: Server performs remote API invocation to the generative AI model, obtains generated text, and executes parsing logic to map unstructured text to structured fields.
Output: Structured destination information including an official facility name and an address string.

### Step 13:

Server resolves destination coordinates using geographic information data.
Server submits the address string and facility name to a geocoding function or a geographic database query. Server executes a search over stored geographic information data, for example, by matching normalized address components and using spatial indices. Server returns a record with latitude and longitude of the resolved facility.
Input: Structured destination information (facility name and address).
Data processing: Server performs address normalization, database lookup, and coordinate extraction from matching records.
Output: Destination coordinates (latitude and longitude) of the candidate location.

### Step 14:

Server generates multiple route candidates from current position to destination.
Server accesses a road network graph stored in a routing database, where each edge includes length and default travel time attributes. Server sets the current position and destination coordinates as nodes or projected positions on the graph. Server runs pathfinding algorithms (for example, Dijkstra's or A* with different heuristic functions or cost weightings) to obtain different route candidates such as fastest, shortest, and fewer-maneuver routes.
Input: Current position coordinates and destination coordinates.
Data processing: Server maps coordinates to graph nodes, then performs graph search algorithms to find multiple paths through the network.
Output: Set of route candidates, each represented as an ordered list of links and nodes with basic cost attributes.

### Step 15:

Server augments route candidates with real-time traffic information.
Server requests traffic information from an external information source via an API, obtaining data such as congestion levels, incidents, and speed limits per road segment ID. Server matches segment IDs in traffic data with links in each route candidate, updates travel time attributes accordingly, and computes route-level travel times and congestion indices by aggregating link-level information.
Input: Route candidates and external traffic information.
Data processing: Server joins route links with traffic records by segment ID, adjusts per-link travel times, and aggregates metrics across each route.
Output: Traffic-augmented route candidates with updated required time, distance, and congestion degree values.

### Step 16:

Server computes psychological load metrics and first/second evaluation values.
Server analyzes each route candidate to count the number of right turns, the number of merge points, and the number of complex intersections by examining geometry and intersection metadata. Server retrieves or calculates a scenery evaluation for each link and averages or sums these values along the route. Server computes a first evaluation value for each route based on required time, distance, and congestion degree, using a weighted sum. Server computes a second evaluation value for each route based on psychological load evaluation indices (numbers of right turns, merge points, complexities, scenery evaluations) using another weighted combination.
Input: Traffic-augmented route candidates and route geometry/intersection metadata.
Data processing: Server performs structural analysis of route sequences, counts specific maneuver types, and computes weighted sums for objective and psychological metrics.
Output: First evaluation value and second evaluation value for each route candidate.

### Step 17:

Server combines evaluation values with the emotion state vector to obtain overall evaluation values.
Server adjusts the weights used in the psychological load evaluation based on the emotion state vector. For example, when the stress index and the anxiety index exceed predefined thresholds, server increases the weight applied to right turns and merge points in the second evaluation value. Server then computes an overall evaluation value for each route by combining the first and second evaluation values, for example with a linear formula where the coefficients depend on the emotion state vector.
Input: First evaluation values, second evaluation values, and emotion state vector.
Data processing: Server scales and combines evaluation components according to stress- and anxiety-dependent weighting functions to derive a scalar score per route.
Output: Overall evaluation value for each route candidate.

### Step 18:

Server selects a recommended route and at least one alternative route.
Server compares overall evaluation values for all route candidates and sorts them in ascending order. Server selects the route with the best (e.g., smallest) overall evaluation value as the recommended route and selects the next-best route or routes as alternative routes. Server compiles a summary of parameters (time, distance, right turns, merges, scenery score) for the selected routes.
Input: Overall evaluation values and associated route candidates.
Data processing: Server performs sorting and selection operations on evaluation values and collates attributes of the selected routes.
Output: Recommended route and alternative route set with associated attributes.

### Step 19:

Server constructs a second prompt sentence for the generative AI model to generate guidance text.
Server converts numeric route attributes and the emotion state vector into descriptive text phrases. Server embeds these phrases into a natural-language template indicating that psychological load reduction is prioritized. For example, server constructs the following prompt sentence:
“You are the navigation system of an autonomous vehicle. The user's emotional state shows high stress and moderately high anxiety, while boredom is low. Route A requires 20 minutes, includes 2 right turns and 1 merge, and passes along a scenic riverside road. Route B requires 15 minutes, includes 5 right turns and 3 merges, and has average scenery. Prioritizing reduction of psychological load, create a 2-3 sentence Japanese explanation that recommends Route A.”
Input: Recommended and alternative route attributes and emotion state vector.
Data processing: Server formats numeric values into text segments and assembles them into an instruction string according to a prompt template.
Output: Second prompt sentence for guidance generation.

### Step 20:

Server requests explanation or proposal text from the generative AI model and post-processes the result.
Server sends the second prompt sentence to the generative AI model via HTTPS and receives a generated explanation text or proposal text. Server optionally applies post-processing rules, such as enforcing polite forms, removing prohibited expressions, or normalizing punctuation.
Input: Second prompt sentence.
Data processing: Server performs an API call to the generative AI model, receives generated text, and applies rule-based string transformations.
Output: Final explanation text for the recommended route and, optionally, proposal text describing route comparisons.

### Step 21:

Server sends the selected routes, guidance texts, and emotion state vector to the terminal.
Server assembles the recommended route geometry, alternative routes, explanation text, proposal text, and emotion state vector into a structured response. Server serializes this data into a JSON string, encrypts the transport with TLS, and transmits the response as an HTTPS reply to the terminal.
Input: Recommended/alternative routes, explanation/proposal texts, and emotion state vector.
Data processing: Server builds a response object, serializes it, and sends it over the secure communication channel.
Output: Encrypted navigation and guidance response delivered to the terminal.

### Step 22:

Terminal receives the response and prepares map and audio guidance.
Terminal accepts the HTTPS response, terminates TLS, and parses the JSON to extract routes, texts, and the emotion state vector. Terminal maps geographic coordinates of the routes to screen coordinates using its map SDK and draws the recommended route prominently and alternative routes in distinct styles. Terminal passes the explanation text to a text-to-speech engine, configures prosody parameters (pitch, speaking rate, intonation) according to the emotion state vector, and synthesizes PCM audio for the guidance message.
Input: Structured response from the server containing routes, texts, and emotion state vector.
Data processing: Terminal performs JSON parsing, coordinate transformation and rendering, and TTS synthesis with emotion-dependent parameter settings.
Output: Rendered navigation map on the display and synthesized audio buffers for route guidance.

### Step 23:

Terminal outputs synchronized visual and spoken guidance to the user.
Terminal sends the synthesized audio buffers to the audio subsystem for playback through the speaker. Terminal updates the display with arrows, distances, and route highlights, synchronized with real-time vehicle position (from GNSS). Terminal schedules playback of guidance phrases (e.g., “Turn right in 500 meters”) based on distance to the next maneuver and vehicle speed.
Input: Synthesized audio data, rendered map, and real-time position updates.
Data processing: Terminal manages audio playback timing and display refresh, computing when to trigger each guidance message.
Output: Audible turn-by-turn instructions and visual navigation cues perceived by the user.

### Step 24:

User reviews the guidance and optionally issues route or destination changes via the terminal.
User observes the on-screen route and listens to the voice instructions. User may tap a “Change route” or “Add stopover” control on the touch panel to modify navigation behavior or destination.
Input: Visual and auditory guidance presented by the terminal.
Data processing: User interprets the guidance and decides whether to interact with the terminal.
Output: Touch gestures or other user operations on the terminal interface.

### Step 25:

Terminal interprets user operations and sends an update request to the server.
Terminal receives raw touch events from the touch controller and maps them to logical commands such as route change or destination change, with associated parameters (e.g., selected alternative route ID or new destination text). Terminal constructs a new JSON message describing the requested operation and context and transmits it securely to the server over HTTPS.
Input: Touch events and current navigation state on the terminal.
Data processing: Terminal translates low-level input events into high-level commands and serializes them into a structured, encrypted request.
Output: Operation request message sent to the server for processing.

### Step 26:

Server processes the update request, recomputes navigation, and logs data for learning.
Server parses the operation request, determines whether to promote an existing alternative route, search new routes, or process a new destination. Server repeats relevant steps (NLP, prompt construction, route generation, evaluation, generative guidance) to compute updated routes and texts, and sends them back to the terminal. Server also logs prompt sentences, generative AI responses, emotion state vectors, evaluation results, and user operations into a storage system. Later, server uses these logs to retrain emotion estimation and route evaluation models and to refine prompt sentence templates.
Input: Operation request message, previous navigation context, and stored model parameters.
Data processing: Server performs conditional logic to trigger re-navigation workflows, executes model-based computations, and appends structured records to logs for offline learning.
Output: Updated navigation responses to the terminal and accumulated training data for model improvement.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

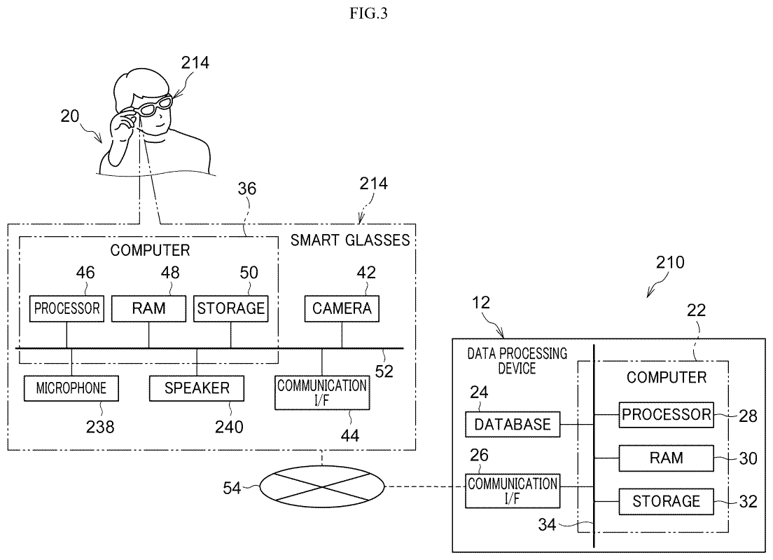

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

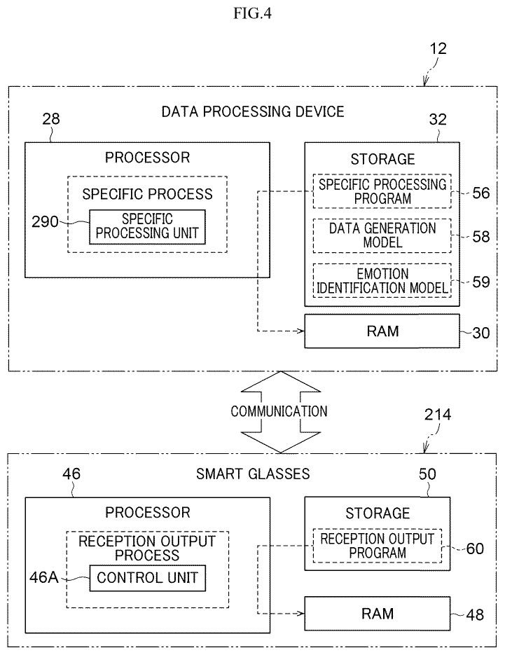

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

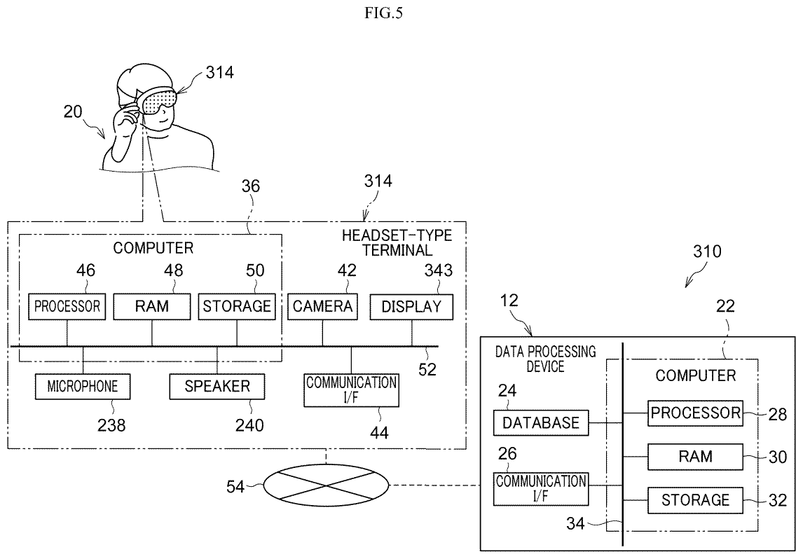

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

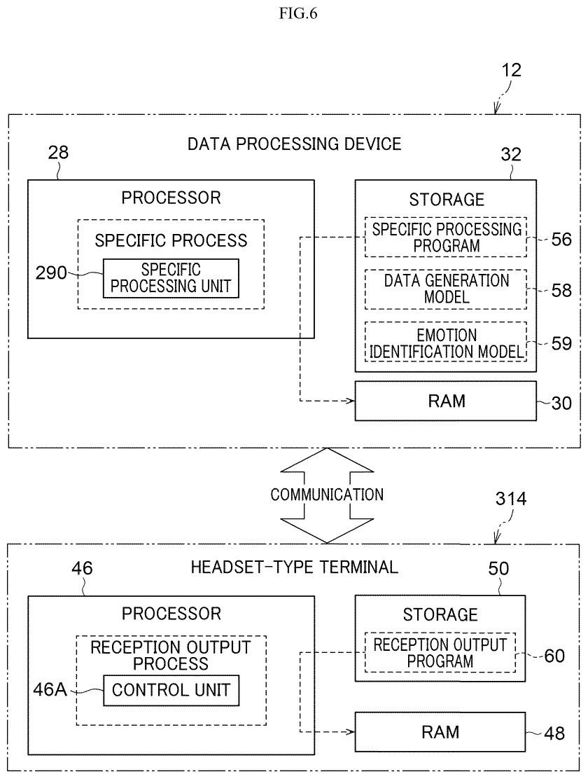

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

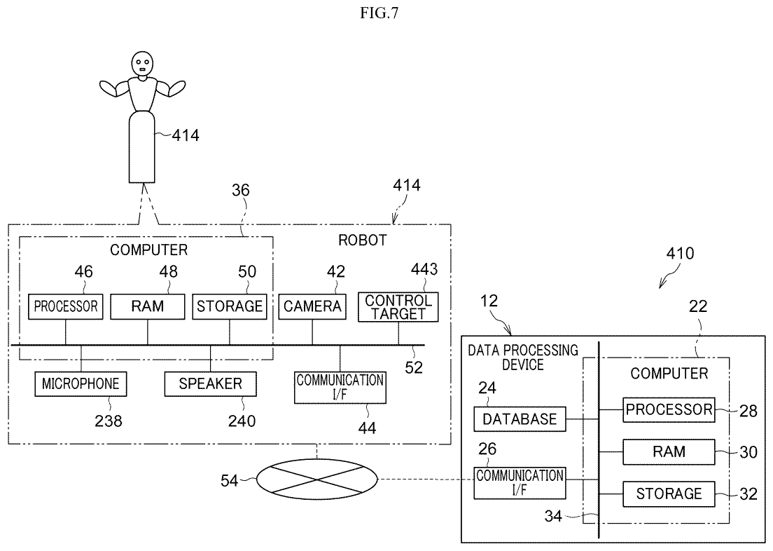

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

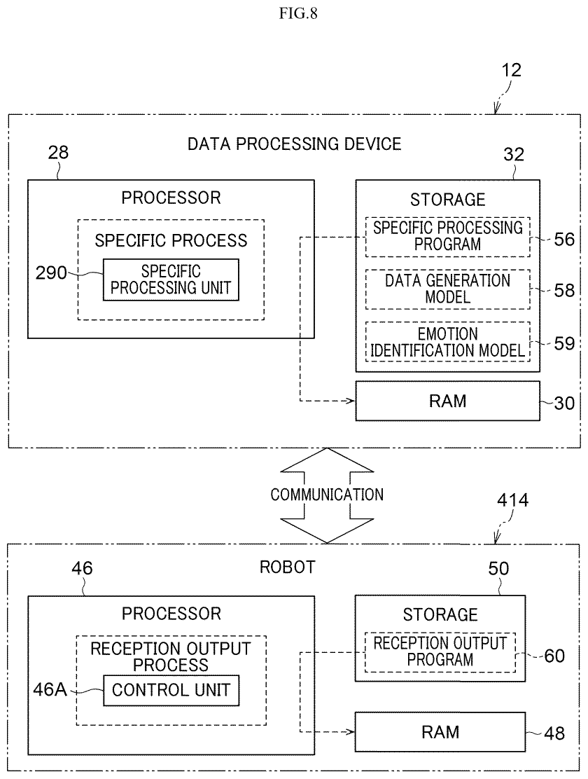

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

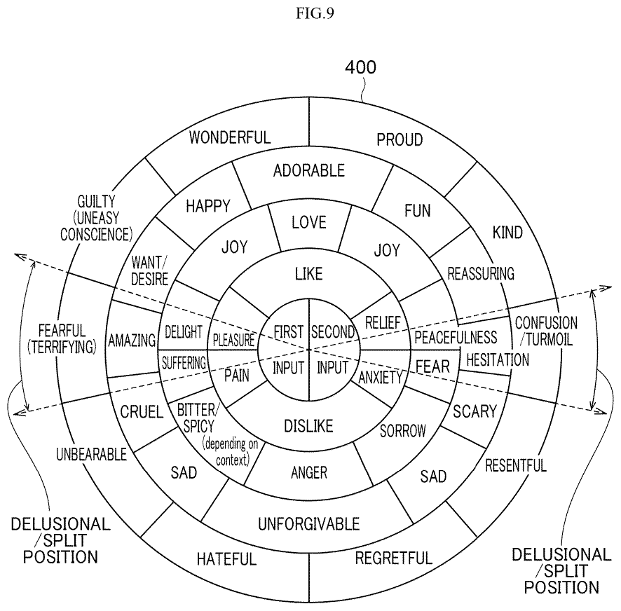

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

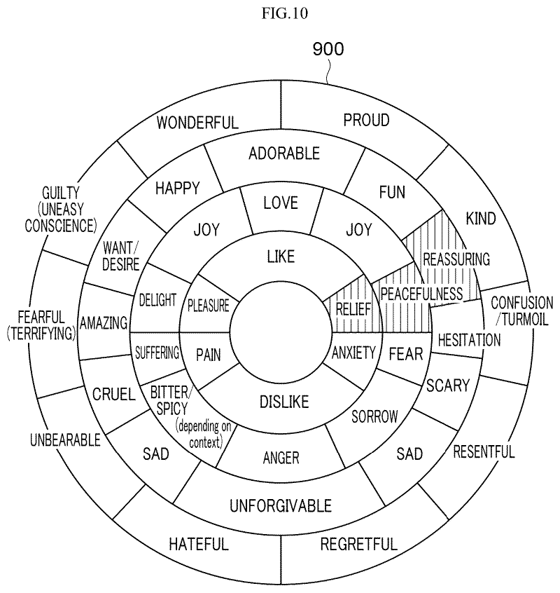

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio input from a vehicle occupant and convert the audio input into text data, and generate a prompt sentence for a generative AI model based on the text data and context information including at least vehicle position information, input the prompt sentence into the generative AI model, obtain structured information including a driver intent and constraint conditions relating to a candidate destination from the generative AI model, and identify the driver intent based on the structured information, and
set a destination based on the structured information and road network information, calculate a travel route by taking into account traffic information and weather information acquired from an external information source, and generate route guidance information based on the calculated travel route and present the route guidance information to the vehicle occupant, and
collect vehicle state data obtained from a detector mounted on the vehicle, analyze the vehicle state data to generate a route change request including at least one of a warning regarding a vehicle state and a recommended stopping location, and update at least one of the destination and the travel route based on the route change request, and
analyze a driving pattern based on acceleration information and angular velocity information acquired during driving, generate a prompt sentence requesting generation of safe-driving advice by the generative AI model based on an analysis result, input the prompt sentence into the generative AI model, obtain advice content from the generative AI model, and present safe-driving advice to the vehicle occupant based on the advice content, and
receive at least one of a voice instruction and an operation input from the vehicle occupant, and update at least one of the destination, the travel route, and the safe-driving advice according to the voice instruction or the operation input.

### (Supplementary 2)

The system according to supplementary 1,

wherein the processor is configured to
aggregate vehicle state data and diagnostic information to generate summary information, generate a prompt sentence including the summary information, input the prompt sentence into the generative AI model to obtain maintenance explanation information, and present, to the vehicle occupant, at least one of an explanation relating to maintenance of the vehicle and a recommended action based on the maintenance explanation information.

### (Supplementary 3)

The system according to supplementary 1,
wherein the processor is configured to
generate statistical information relating to the driving pattern, generate a prompt sentence including the statistical information, input the prompt sentence into the generative AI model to obtain personalized safe-driving guidance for the vehicle occupant, and present the safe-driving guidance to the vehicle occupant by at least one of audio output and visual display.

### Application Example 1

### (Supplementary 1)

A system comprising a processor,
wherein the processor is configured to
acquire and pre-process audio information,
convert the audio information into character information,
extract intention information and target information from the character information, obtain instruction information based on the intention information, the target information, and situation information by generating and transmitting a prompt sentence to a generative information processing model and by receiving response information from the generative information processing model to supplement the intention information and the target information, acquire position information and route information and generate and evaluate a plurality of movement route candidates based on the supplemented intention information and target information,
acquire history information and preference information for each user and obtain route evaluation indices based on the history information, the preference information, and a current movement request by generating and transmitting a prompt sentence to the generative information processing model and by dynamically setting evaluation conditions for the plurality of movement route candidates based on response information received from the generative information processing model to select an optimal route,
generate guidance information based on the optimal route and present the guidance information to the user as audio information and display information, and
acquire operation information and route change information from the user, record the operation information and the route change information as the history information and the preference information, and store the operation information and the route change information as learning information for updating generation conditions of the prompt sentence for the generative information processing model.

### (Supplementary 2)

The system according to supplementary 1,
wherein the processor is configured to
acquire vehicle state information,
generate evaluation information relating to safety based on the vehicle state information and driving behavior information, present advice information corresponding to the evaluation information to the user as audio information and display information, and reflect the evaluation information and response information from the user as the history information in the generation conditions of the prompt sentence for the generative information processing model.

### (Supplementary 3)

The system according to supplementary 1,
wherein the processor is configured to
acquire traffic information and environment information from an external information source via a communication line,
reflect the traffic information and the environment information in generation and evaluation of the plurality of movement route candidates, and
add situation information including the traffic information and the environment information to the prompt sentence for the generative information processing model to obtain the instruction information and the route evaluation indices.

### Example 2

### (Supplementary 1)

A system comprising a processor,
wherein the processor is configured to
receive an acoustic signal acquired in a vehicle cabin and convert the acoustic signal into text data representing a speech content of a user by executing a speech recognition function,
analyze the text data by executing a natural language processing function to identify an intention of the user, and, by inputting a prompt sentence to a generative AI model, cause the generative AI model to estimate an emotional state of the user and a support policy on the basis of the text data and emotion recognition features, and obtain an analysis result including the emotional state and the support policy,
access geographic spatial data and traffic state information, extract candidate destinations, and execute route search while changing evaluation criteria for a destination and a route according to intention information and the emotional state included in the analysis result, so as to generate optimal route information,
generate, on the basis of the optimal route information and the emotional state, a prompt sentence for the generative AI model, cause the generative AI model to generate guidance message text adapted to the emotional state of the user in response to the prompt sentence, and control output formats of voice guidance and visual guidance on the basis of the guidance message text,
extract, from the acoustic signal, emotion recognition features including at least a fundamental frequency value, an energy value, a speech rate value, a silence duration value, and a spectral characteristic value, integrate the emotion recognition features with a text emotion analysis result obtained by analyzing the text data, and generate integrated emotional state information representing the emotional state of the user,
acquire vehicle state information and driving behavior information from state detection sensors and behavior detection sensors mounted on a vehicle, associate the vehicle state information and the driving behavior information with the integrated emotional state information as history data, store the history data, and update, for each user, contents of the prompt sentence to be input to the generative AI model and an output style of a guidance message on the basis of the history data.

### (Supplementary 2)

The system according to supplementary 1,
wherein the processor is configured to
acquire vehicle information including at least a fuel remaining amount, a tire pressure value, a power system state, a braking system state, an acceleration value, an angular velocity value, and
a sudden operation event from a group of vehicle state detection sensors and a group of driving behavior detection sensors,
evaluate a safe driving risk on the basis of the vehicle information and the integrated emotional state information, generate a prompt sentence including an evaluation result of the safe driving risk, cause the generative AI model to generate a safe driving advice message in response to the prompt sentence, and present the safe driving advice message to the user by voice output or display output.

### (Supplementary 3)

The system according to supplementary 1,
wherein the processor is configured to
acquire traffic state information and environmental state information from an external information providing apparatus via a communication function,
assign the traffic state information and the environmental state information as link costs in the route search executed by the processor, and, by changing evaluation weights for at least a congestion section, a toll section, and a hazardous section in accordance with the integrated emotional state information, evaluate a plurality of route candidates and select the optimal route information.

### Application Example 2

### (Supplementary 1)

A system comprising a processor,
wherein the processor is configured to
acquire a voice of a user through an input device and generate voice data,
perform noise reduction processing and utterance section extraction processing on the voice data to calculate speech recognition features and acoustic features for emotion estimation,
convert the voice data into text data based on the speech recognition features,
perform natural language processing on the text data to identify an intention of the user and information relating to a destination, and to extract a candidate location corresponding to the destination,
calculate an emotion state vector including, as elements, at least a stress index, an anxiety index, a boredom index, and a satisfaction index, based on the text data and the acoustic features for emotion estimation,
generate a prompt sentence including the text data and current position information of the user, input the prompt sentence to a generative AI model, obtain a text response relating to an official name and position information of the candidate location from the generative AI model, and specify coordinates of the candidate location based on geographic information data,
generate a plurality of route candidates based on the current position information and the coordinates of the candidate location, calculate, for each of the route candidates, a first evaluation value based on evaluation indices including at least required time, distance, and congestion degree derived from traffic information acquired from an external information source, and a second evaluation value based on psychological load evaluation indices including at least a number of right turns, a number of merge points, a complexity of intersections, and a scenery evaluation, calculate an overall evaluation value for each of the route candidates according to at least the emotion state vector including at least the stress index and the anxiety index and the first and second evaluation values, and select a recommended route based on the overall evaluation values,
generate a prompt sentence to be input to the generative AI model by using the emotion state vector and information relating to the route candidates including the recommended route, input the prompt sentence to the generative AI model, and cause the generative AI model to generate, as a response to the prompt sentence, an explanation text relating to the recommended route or a proposal text relating to the route candidates, and
output route guidance to the user through a display device and a voice output device based on the recommended route and the explanation text or the proposal text.

### (Supplementary 2)

The system according to supplementary 1,
wherein the processor is configured to
dynamically change weight values of the psychological load evaluation indices based on the emotion state vector and the numbers of right turns, the numbers of merge points, the complexities of intersections, and the scenery evaluations for the respective route candidates, and, when the stress index and the anxiety index are high, increase weights corresponding to at least the numbers of right turns and the numbers of merge points so as to increase the overall evaluation values of route candidates having high psychological load and thereby reflect the increased overall evaluation values in selection of the recommended route.

### (Supplementary 3)

The system according to supplementary 1,
wherein the processor is configured to
record the prompt sentence input to the generative AI model, a text response output from the generative AI model, the emotion state vector, evaluation results relating to the recommended route and the route candidates, and history information relating to a route change operation or a destination change operation performed by the user, and, based on the recorded information, learn or update an emotion estimation model and a route evaluation model and improve a template of the prompt sentence to be input to the generative AI model.

What is claimed is:

1. A system comprising:
circuitry configured to:
receive, via a communication interface coupled to a packet-switched network, audio data from a terminal device and convert the audio data into text data;
analyze the text data to determine an intent and extract destination information;
acquire real-time environmental condition data from one or more external data sources via the packet-switched network;
calculate a route to the destination based on the environmental condition data; and
generate guidance data and transmit the guidance data to the terminal device via the communication interface.

2. The system according to claim 1, wherein the circuitry converts the audio data into the text data using a speech recognition model, and analyzes the text data using a natural language processing model to determine the intent.

3. The system according to claim 2, wherein the circuitry constructs a prompt data structure encoding the text data and the determined intent, transmits the prompt data structure to a generative neural network model comprising a transformer-based architecture, and receives parsed intent data and destination data with disambiguation when the text data contains ambiguous location references.

4. The system according to claim 3, wherein the environmental condition data includes at least traffic congestion data, incident data, construction data, and weather data, and wherein the circuitry evaluates a plurality of candidate routes based on estimated travel time, distance, and safety scores derived from the environmental condition data.

5. The system according to claim 4, wherein the circuitry dynamically recalculates the route during navigation in response to updated environmental condition data received from the external data sources, and transmits updated guidance data to the terminal device.

6. The system according to claim 1, wherein the circuitry converts the guidance data into synthesized audio data using a speech synthesis model and transmits the synthesized audio data to the terminal device for audible output to a user.

7. The system according to claim 1, wherein the circuitry is further configured to receive sensor data from the terminal device, the sensor data including at least one of fuel level data, tire pressure data, and engine status data acquired from vehicle-mounted sensors coupled to the terminal device.

8. The system according to claim 7, wherein the circuitry analyzes the sensor data to detect values outside predetermined normal ranges, generates vehicle condition alert data, and transmits the vehicle condition alert data to the terminal device.

9. The system according to claim 8, wherein the circuitry incorporates the vehicle condition data into route calculation by adjusting route selection to prioritize routes with service facilities when the sensor data indicates a maintenance condition.

10. The system according to claim 1, wherein the circuitry is further configured to receive motion sensor data from the terminal device including acceleration data and gyroscope data, and to analyze the motion sensor data to detect driving behavior patterns including sudden braking events and sudden acceleration events.

11. The system according to claim 10, wherein the circuitry calculates a driving behavior score based on frequency and severity of detected events over a time window, and generates advisory data including specific behavioral recommendations when the driving behavior score falls below a threshold.

12. The system according to claim 11, wherein the circuitry constructs a prompt data structure encoding the driving behavior score and detected event patterns, transmits the prompt data structure to a generative neural network model, and receives personalized advisory text adapted to the detected behavior patterns.

13. The system according to claim 1, wherein the circuitry maintains a dialog context across a plurality of voice interactions within a navigation session, and generates contextual responses to follow-up queries from the user without requiring re-specification of the destination.

14. The system according to claim 13, wherein the circuitry receives preference data from the terminal device indicating preferred route characteristics, stores the preference data in a user profile in a storage device, and applies the preference data to subsequent route calculations.

15. The system according to claim 1, wherein the circuitry is further configured to predict arrival time based on the route and the environmental condition data, and to transmit updated arrival time estimates to the terminal device at periodic intervals.

16. The system according to claim 15, wherein the circuitry transmits the arrival time estimate and current position data to one or more designated recipient terminal devices via the communication interface to enable location sharing.

17. The system according to claim 1, wherein the circuitry estimates a fatigue level of the user based on voice characteristics extracted from the audio data including speech rate degradation and response latency increases over time, and generates rest recommendation data when the estimated fatigue level exceeds a threshold.

18. A system comprising:
circuitry configured to:
receive, via a communication interface coupled to a packet-switched network, audio data from a terminal device and convert the audio data into text data using a speech recognition model;
analyze the text data using a natural language processing model and a generative neural network model comprising a transformer architecture to determine an intent and extract destination information with disambiguation;
acquire real-time environmental condition data including traffic congestion data, incident data, and weather data from external data sources via the packet-switched network;
calculate a route based on the environmental condition data and dynamically recalculate the route in response to updated environmental condition data;
receive sensor data and motion sensor data from the terminal device, detect driving behavior patterns, and generate condition alerts and driving behavior analysis; and
generate guidance data and advisory data and transmit the guidance data and advisory data to the terminal device via the communication interface.

19. The system according to claim 18, wherein the circuitry is further configured to estimate a fatigue level of the user based on voice characteristics and to generate rest recommendation data when the fatigue level exceeds a threshold.

20. A method performed by circuitry of a server coupled to a packet-switched network via a communication interface, the method comprising:
receiving, via the communication interface, audio data from a terminal device and converting the audio data into text data;
analyzing the text data to determine an intent and extract destination information;
acquiring real-time environmental condition data from one or more external data sources via the packet-switched network;
calculating a route to the destination based on the environmental condition data; and
generating guidance data and transmitting the guidance data to the terminal device via the communication interface.
